(19) United States
(12) Patent Application Publication
(10) Pub. No.: US 2026/0367548 A1
(43) Pub. Date: Nov. 19, 2026

(54) FIXING DEVICE AND IMAGE FORMING APPARATUS

(71) Applicant: CANON KABUSHIKI KAISHA, Tokyo (JP)

(72) Inventors: RIKIYA TAKEMASA, Chiba (JP); TAKUYA HASEGAWA, Tokyo (JP); KENICHI TANAKA, Ibaraki (JP); TAKESHI KOZUMA, Ibaraki (JP); TATSUO YASUI, Tokyo (JP); MASAKI FURUTANI, Chiba (JP)

(21) Appl. No.: 19/666,544

(22) Filed: May 4, 2026

(30) Foreign Application Priority Data
May 17, 2025 (JP) 2025-082981
Apr. 24, 2026 (JP) 2026-072857

(51) Int. Cl. G03G 15/20; G03G 21/16

(52) U.S. Cl. CPC G03G 15/2025; G03G 15/2064; G03G 21/1647; G03G 2221/1639; G03G 2221/1657

(57) ABSTRACT

A fixing device for heating and fixing a toner image includes a fixing rotatable member supported by a first supporting member, and a rubbing rotatable member supported by a second supporting member. The second supporting member rotates relative to the first supporting member to move the rubbing member between a contact position and a separated position. A separating/contacting mechanism rotates the second supporting member to achieve the movement. A drive input member, coaxial with and rotating integrally with the fixing rotatable member, transmits a driving force to a driving member that rotates integrally with the rubbing rotatable member. A drive transmission member, rotatable about an axis of the second supporting member, transfers the driving force from the drive input member to the driving member. The separating/contacting mechanism rotates the second supporting member while maintaining drive-connected during movement between the contact and separated positions of the rubbing member.

### BACKGROUND

### Field of the Technology

The present invention relates to a fixing device which heats a toner image on a recording material, and an image forming apparatus using an electrophotographic type or an electrostatic recording type, such as a copying machine, a printer, and a facsimile device or a multifunction machine provided with a plurality of functions of these, provided with the fixing device.

### Description of the Related Art

In an image forming apparatus such as a copy machine using an electrophotographic type or an electrostatic recording type, forming a toner image on a recording material having a sheet shape, and fixing the toner image on the recording material onto the recording material by heating and pressing the toner image with a fixing device (fixing operation) are performed. As the fixing device, a device having a configuration, in which a heating rotatable member which heats the toner image on the recording material, and a pressing rotatable member which is in press contact with the heating rotatable member, is widely used.

In such a fixing device, in a case in which a number of recording material to which the fixing process is applied increases, by cut end portions which are generated upon cutting of the recording material (hereinafter, referred to as "paper edges"), scratches may be generated along a circumferential direction on a surface of the heating rotatable member and/or the pressing rotatable member. Then, the scratches may appear as streaks also on an image after the fixing.

To this problem, in Japanese Patent Application Laid-Open No. 2017-32898, a configuration in which a refreshing operation, which is an operation of bringing a rubbing member into contact with the heating rotatable member and/or the pressing rotatable member, and rubbing the surface of the heating rotatable member and/or the pressing rotatable member which contacts the paper edges, is performed is disclosed. In the refreshing operation, adjusting (smoothing) a surface state of the heating rotatable member and/or the pressing rotatable member to a surface state in which the streaks on the image after the fixing due to the scratches generated by the paper edges become inconspicuous is performed.

In the configuration described in Japanese Patent Application Laid-Open No. 2017-32898, a refreshing roller as a rubbing rotatable member is disposed opposite to a pressing roller. In addition, the refreshing roller is rotatably supported by a rotatable supporting member. The refreshing roller is, by the supporting member being rotated by rotation of an attaching/detaching cam being controlled, brought into contact with and separated from the pressing roller. A driving gear is provided at an end portion of the refreshing roller, and this driving gear is meshed with an idler gear which is provided to the supporting member. Then, upon the supporting member being rotated and the refreshing roller being in contact with the pressing roller, the idler gear, which is provided to the supporting member, is meshed with a drive input gear provided at an end portion of the pressing roller, and is drive-connected. As a result, the refreshing roller is rotated, in a state of being in contact with the pressing roller, with a predetermined peripheral speed difference to the pressing roller, and rubs the surface of the pressing roller.

### SUMMARY

According to an aspect of the present invention, there is provided a fixing device for heating a toner image on a recording material nipped and conveyed in a fixing nip portion, and for fixing the toner image onto the recording material, the fixing device comprising: a fixing rotatable member configured to form the fixing nip potion; a first supporting member configured to support the fixing rotatable member; a rubbing rotatable member configured to rub a surface of the fixing rotatable member; a second supporting member configured to support the rubbing rotatable member, the second supporting member being rotatable relative to the first supporting member so as to move the rubbing rotatable member between a first position where the rubbing rotatable member is in contact with the fixing rotatable member and a second position where the rubbing rotatable member is separated from the fixing rotatable member; a separating/contacting mechanism configured to rotate the second supporting member; a drive input member provided coaxially with the fixing rotatable member and configured to be rotated integrally with the fixing rotatable member; a driving member provided coaxially with the rubbing rotatable member and configured to be rotated integrally with the rubbing rotatable member; and a drive transmission member configured to transmit a driving force received from the drive input member toward the driving member, wherein the drive transmission member is rotatably provided about a rotational axis of the second supporting member, wherein the drive input member is engaged with the drive transmission member in a state in which the fixing rotatable member is supported by the first supporting member, and wherein the separating/contacting mechanism rotates the second supporting member so as to move the rubbing rotatable member to the first position and the second position in a state of being drive-connected to the driving member from the drive input member via the drive transmission member.

Further features of the present invention will become apparent from the following description of exemplary embodiments with reference to the attached drawings.

### BRIEF DESCRIPTION OF THE DRAWINGS

FIG. 1 is a cross-sectional view illustrating an outline configuration of an image forming apparatus.

FIG. 2 is a cross-sectional view illustrating an outline configuration of a fixing device.

FIG. 3 is a schematic cross-sectional view of a refreshing roller.

FIG. 4 is a block diagram illustrating an outline of a control configuration of the image forming apparatus.

FIG. 5, part (a) and part (b), includes graph views for describing surface states of a fixing belt and a pressing roller before and after execution of a refreshing mode.

FIG. 6A is a perspective view illustrating a pressing roller separating/contacting mechanism and a pressing refreshing roller separating/contacting mechanism.

FIG. 6B is a perspective view illustrating the pressing roller separating/contacting mechanism and the pressing refreshing roller separating/contacting mechanism.

FIG. 7, part (a) and part (b), includes partial cross-sectional views for describing a separating/contacting operation for the pressing refreshing roller with respect to the pressing roller when the pressing roller is at a separated position.

FIG. 8, part (a) and part (b), includes partial cross-sectional views for describing the separating/contacting operation for the pressing refreshing roller with respect to the pressing roller when the pressing roller is at the separated position.

FIG. 9, part (a) and part (b), includes partial cross-sectional views for describing the separating/contacting operation for the pressing refreshing roller with respect to the pressing roller when the pressing roller is at a contact position.

FIG. 10, part (a) and part (b), includes partial cross-sectional views for describing the separating/contacting operation for the pressing refreshing roller with respect to the pressing roller when the pressing roller is at the contact position.

FIG. 11 is a perspective view illustrating a fixing belt and a fixing belt refreshing roller separating/contacting mechanism in an Embodiment 2.

FIG. 12, part (a) and part (b), includes partial cross-sectional views when a belt refreshing roller is at a separated position with respect to the fixing belt.

FIG. 13, part (a) and part (b), includes partial cross-sectional views when the belt refreshing roller is at a contact position with respect to the fixing belt.

FIG. 14 is a perspective view illustrating a fixing belt and a fixing belt refreshing roller separating/contacting mechanism in an Embodiment 3.

FIG. 15 is a relationship view between an attaching/detaching position of a belt refreshing roller with respect to the belt and a cleaning roller.

FIG. 16, part (a) and part (b), includes partial cross-sectional views for describing the attaching/detaching position of the belt refreshing roller with respect to the belt and a contact pressure of the cleaning roller.

FIG. 17 is a partial cross-sectional view illustrating a relationship among the attaching/detaching position of the belt refreshing roller with respect to the belt, the cleaning roller, and a cleaning roller urging spring.

### DESCRIPTION OF THE EMBODIMENTS

Hereinafter, a fixing device and an image forming apparatus according to the present invention will be described in more detail with reference to the drawings.

### Embodiment 1

### Configuration of an image forming apparatus

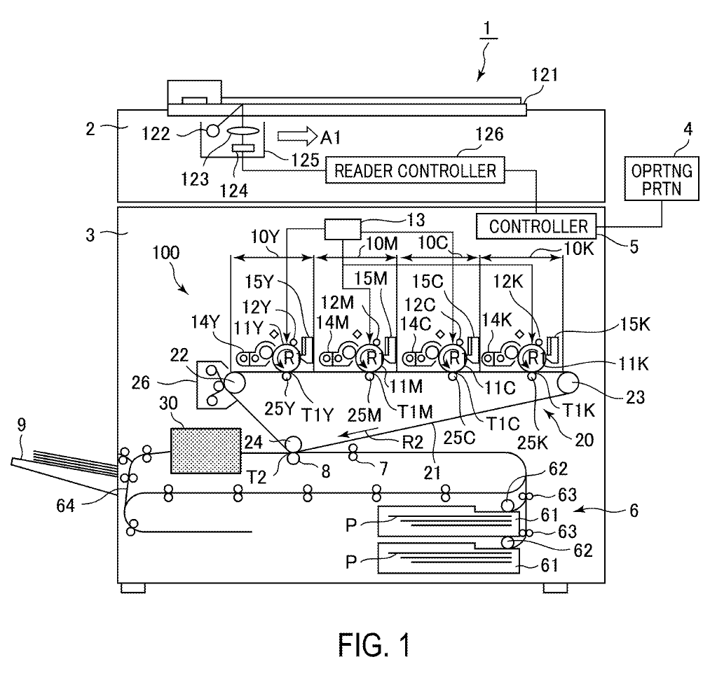

First, a configuration of an image forming apparatus in the present Embodiment will be described. FIG. 1 is a cross-sectional view illustrating an outline configuration of an image forming apparatus 1 in the present Embodiment. In the present Embodiment, the image forming apparatus 1 is an image forming apparatus of tandem type employing an intermediary transfer type, which is capable of forming a full-color image on a recording material P having a sheet shape using an electrophotographic type.

Incidentally, as to the image forming apparatus 1 and elements thereof, a front side of a paper of FIG. 1 is defined as a “front (front surface)” side, and a back side of the paper of FIG. 1 is defined as a “rear (back surface)” side. A direction perpendicular to the paper of FIG. 1 connecting the front side and the rear side of the image forming apparatus 1 (front-rear direction) is assumed to be approximately parallel to a rotational axis direction of a photosensitive drum 11, which will be described below. In addition, up and down refer to up and down in a direction of gravity (vertical direction), however, it does not mean only directly above and directly below, but includes an upside and a downside of a horizontal plane passing through an element and/or a position of interest. In addition, as the recording material (recording medium, transfer material, sheet) on which the image is formed in the image forming apparatus 1, paper is typically used. Therefore, here, the recording material may be referred to as a “paper”, a “sheet”, etc. However, the recording material is not limited to paper, but may be material formed of material other than paper such as a plastic sheet or material including material other than paper. In addition, a type of the recording material (paper type) includes arbitrary information, with which the recording material is distinguishable, such as an attribute based on a general characteristic such as a plain paper, a coated paper, a thick paper, and a synthetic paper (so-called, paper type category), a numerical value and/or a numerical value range such as a basis weight and a thickness, and a brand (including a maker, a product number, etc.).

The image forming apparatus 1 includes an image reading portion (reader portion) 2 and a printer portion (image forming apparatus main assembly) 3. The image reading portion 2 reads an original placed on an original table glass 121. The image reading portion 2 includes an optical system unit 125 provided with a light source 122, an optical system member 123 such as a lens, and a CCD sensor 124. In the optical system unit 125, light irradiated from the light source 122 is reflected by the original, and forms an image on the CCD sensor 124 via the optical system member 123 such as the lens. The optical system unit 125 in this manner converts the original, by being moved in a direction of an arrow A1 in FIG. 1 and scanning the original, into an electric signal data sequence for each line. An image signal obtained by the CCD sensor 124 is sent, via a reader control portion 126, to a control portion 5 provided in the printer portion 3. And in the control portion 5, to this image signal, image processing corresponding to an image forming portion 100, which will be described below, is applied. In addition, as the image signal, the control portion 5 may also receive an external input from an external host device such as a print server (for example, a personal computer).

The printer portion 3 includes, as a plurality of image forming units, four image forming units 10Y, 10M, 10C, and 10K, which form images of a yellow color (Y), a magenta color (M), a cyan color (C), and a black color (K), respectively. Incidentally, configurations of the respective image forming units 10Y, 10M, 10C, and 10K are substantially the same except that colors of toners to be used are different. Elements having the same or corresponding functions or configurations, which are provided for each color, may be described collectively by omitting Y, M, C and K at the ends of reference numerals indicating that the element is for either one of the colors. The image forming unit 10 is constituted by a photosensitive drum 11 (11Y, 11M, 11C, 11K), a charging roller 12 (12Y, 12M, 12C, 12K), an exposure device 13, a developing device 14 (14Y, 14M, 14C, 14K), a drum cleaning device 15 (15Y, 15M, 15C, 15K), etc., which will be described below. In the present Embodiment, the exposure device 13 is configured as one unit which irradiates the photosensitive drum 11 in each image forming unit 10 with light. However, the exposure device 13 may be provided independently for each image forming unit 10. In each image forming unit 10, image formation is performed based on the image signal described above.

The photosensitive drum 11, which is a photosensitive member (electrophotographic photosensitive member) having a drum shape (cylindrical shape), as a first image bearing member is rotationally driven in a direction of an arrow R1 (counterclockwise direction) in FIG. 1. A surface of the rotating photosensitive drum 11 is uniformly charged, by the charging roller 12 which is a charging member (charger) having a roller shape as a charging means, to a predetermined potential of a predetermined polarity (negative polarity in the present Embodiment).

The charged surface of the photosensitive drum 11 is scanned and exposed in accordance with the image signal by the exposure device 13, and an electrostatic latent image (electrostatic image) is formed on the photosensitive drum 11. The image signal is converted into a laser beam, which is subjected to pulse width modulation (PWM), controlled by the control portion 5. The exposure device 13 is configured to include a polygon scanner, scans the laser beam in accordance with the image signal, and irradiates the photosensitive drum 11 in each image forming unit 10 with the laser beam. The electrostatic latent image formed on the photosensitive drum 11 is developed (visualized) by the toner as developer being supplied by the developing device 14 as a developing means, and a toner image (developer image) is formed on the photosensitive drum 11. In the present Embodiment, to an exposed portion on the photosensitive drum 11, in which an absolute value of the potential is decreased by being exposed after having been uniformly charged, the developing device 14 causes the toner charged to the same polarity as the charging polarity of the photosensitive drum 11 (negative polarity in the present Embodiment) to be adhered. In the present Embodiment, a normal charging polarity of the toner, which is a main charging polarity of the toner during development, is negative polarity.

So as to be opposite to the four photosensitive drums 11, an intermediary transfer unit 20 is disposed. The intermediary transfer unit 20 includes, as a second image bearing member, an intermediary transfer belt 21 which is an intermediary transfer member constituted by an endless belt. The intermediary transfer belt 21 is wound around a driving roller 22, a tension roller 23, and a secondary transfer opposite roller 24 as a plurality of stretching rollers, and is stretched at a predetermined tensile force. The intermediary transfer belt 21 is rotated (circularly moved), by the driving roller 22 being rotationally driven, in a direction of an arrow R2 (clockwise direction) in FIG. 1. On an inner peripheral surface side of the intermediary transfer belt 21, corresponding to the respective photosensitive drums 11Y, 11M, 11C, and 11K, primary transfer rollers 25Y, 25M, 25C, and 25K, which are primary transfer members having roller shapes, as primary transfer means, are disposed. The primary transfer roller 25 is pressed toward the photosensitive drum 11 across the intermediary transfer belt 21, and forms a primary transfer portion (primary transfer nip portion) T1, which is a contacting portion between the photosensitive drum 11 and the intermediary transfer belt 21. The stretching rollers other than the driving roller 22 and each primary transfer roller 25 are rotated driven by the rotation of the intermediary transfer belt 21. The toner image formed on the photosensitive drum 11 is transferred (primarily transferred), in the primary transfer portion T1, onto the rotating intermediary transfer belt 21. During primary transfer, to the primary transfer roller 25, a primary transfer bias (primary transfer voltage) having an opposite polarity to the normal charging polarity of the toner (positive polarity in the present Embodiment) is applied. As a result, the primary transfer roller 25 performs electric discharge from the inner peripheral surface of the intermediary transfer belt 21, and causes the toner image on the photosensitive drum 11 to be transferred onto the intermediary transfer belt 21. For example, during formation of a full-color image, the toner images of respective colors of yellow, magenta, cyan, and black formed on the respective photosensitive drums 11Y, 11M, 11C, and 11K are sequentially transferred so as to be superimposed on the same image forming area on the intermediary transfer belt 21. The surface of the photosensitive drum 11 after the primary transfer is cleaned by the drum cleaning device 15 as a photosensitive member cleaning means.

On an outer peripheral surface side of the intermediary transfer belt 21, at a position opposite to the secondary transfer opposite roller 24 across the intermediary transfer belt 21, a secondary transfer roller 8, which is a secondary transfer member having a roller shape, as a secondary transfer means is disposed. The secondary transfer roller 8 is pressed toward the secondary transfer opposite roller 24 across the intermediary transfer belt 21, and forms a secondary transfer portion (secondary transfer nip portion) T2, which is a contacting portion between the intermediary transfer belt 21 and the secondary transfer roller 8. In the present Embodiment, the secondary transfer roller 8 is rotated driven by the rotation of the intermediary transfer belt 21. The toner image formed on the intermediary transfer belt 21 is transferred (secondarily transferred), in the secondary transfer portion T2, onto the recording material P which is being nipped and conveyed by the intermediary transfer belt 21 and the secondary transfer roller 8. During secondary transfer, to the secondary transfer roller 8, a secondary transfer bias (secondary transfer voltage) having the opposite polarity to the normal charging polarity of the toner (positive polarity in the present Embodiment) is applied. As a result, the secondary transfer roller 8 forms a secondary transfer electric field in the secondary transfer portion T2, and causes the toner image on the intermediary transfer belt 21 to be transferred onto the recording material P. The surface of the intermediary transfer belt 21 after the secondary transfer is cleaned by a belt cleaning device 26 as an intermediary transfer member cleaning means. In the present Embodiment, the intermediary transfer unit 20 is configured to include the intermediary transfer belt 21, the respective stretching rollers 22, 23, and 24, the respective primary transfer rollers 25, the belt cleaning device 26, etc.

The recording material P is fed from a feeding portion 6 as a feeding means, and is conveyed toward the secondary transfer portion T2. The feeding portion 6 is configured to include a cassette 61 as an accommodating portion, a feeding roller 62 as a feeding member, a conveyance roller 63 as a conveyance member, etc. The recording material P accommodated in the cassette 61 is separated one by one by the feeding roller 62, etc., and sent out from the cassette 61. This recording material P is conveyed, by the conveyance roller 63, to a registration roller pair (registration portion) 7 as a synchronizing conveyance member. The recording material P is conveyed, after being made to wait by the registration roller pair 7, with a timing being controlled in order to align positions between the toner image on the intermediary transfer belt 21 and the recording material P, to the secondary transfer portion T2 by the registration roller pair 7.

The recording material P, onto which the toner image has been transferred, is conveyed to a fixing device 30 which is an image heating device as a fixing means. The fixing device 30 heats and presses the recording material P carrying the unfixed toner image, and fixes (melts, sticks) the toner image onto the recording material P (fixing operation, fixing process). In a case of a single-sided printing, the recording material P, to which the toner image has been fixed by passing through the fixing device 30, is thereafter discharged (output) to an outside of the image forming apparatus 1 (outside the machine), and is stacked on a discharge tray 9 as a discharging portion. In a case of a double-sided printing, when the transfer and the fixing of the toner image to a first side (first side for image formation) of the recording material P are completed, the recording material P is conveyed to a reversing portion 64 provided inside the printer portion 3. And the transfer and the fixing of the toner image to a second side (second side for image formation) of the recording material P, of which front and back sides have been reversed in the reversing portion 64, are performed. This recording material P is, thereafter, discharged outside the machine, and is stacked on the discharge tray 9.

In the present Embodiment, the image forming portion 100, which forms the toner image on the recording material P, is constituted by the respective image forming units 10, the intermediary transfer unit 20, the secondary transfer roller 8, etc.

### Outline configuration of the fixing device

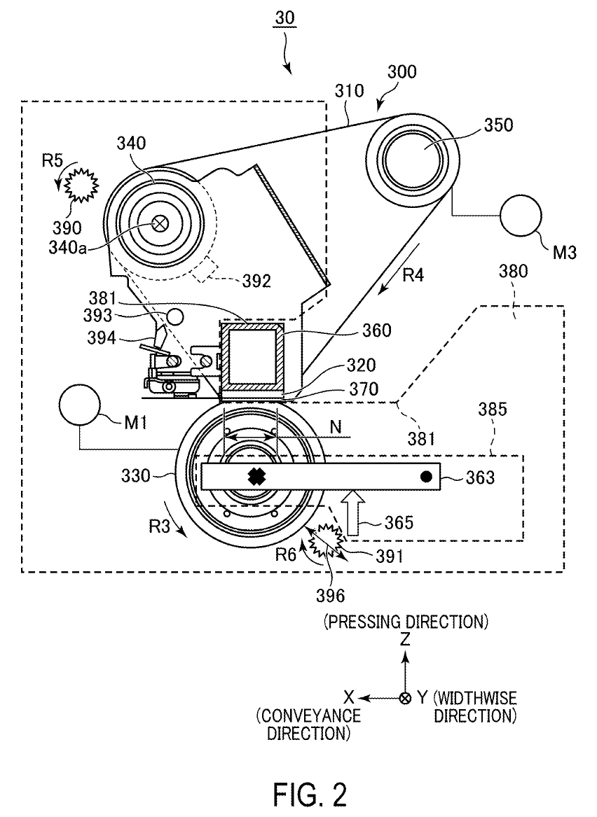

Next, an outline configuration of the fixing device 30 in the present Embodiment will be described. In the present Embodiment, the fixing device 30 is a fixing device of belt heating type. FIG. 2 is a cross-sectional view illustrating the outline configuration of the fixing device 30 in the present Embodiment (illustrating a cross section perpendicular to a rotational axis direction of a pressing roller 330 and a heating roller 340, which will be described below).

Incidentally, in FIG. 2, an X direction indicates a conveyance direction of the recording material P, a Y direction indicates a widthwise direction of the recording material P perpendicular to the conveyance direction of the recording material P, and a Z direction indicates a direction perpendicular to both the X direction and the Y direction. The Y direction is approximately parallel to the rotational axis direction (a longitudinal direction) of the pressing roller 330 and the heating roller 340, which will be described below. In addition, the Z direction is approximately parallel to a direction (pressing direction) in which the recording material P is pressed against a pressing pad 320 across a fixing belt 310 by the pressing roller 330 as described below. In the present Embodiment, the fixing device 30 is disposed so that the Y direction becomes approximately parallel to the front-rear direction connecting the front side and the rear side of the image forming apparatus 1. In addition, in the present Embodiment, the fixing device 30 is disposed so that the Z direction becomes approximately parallel to the direction of gravity.

The fixing device 30 includes the fixing belt 310 which is a heating rotatable member constituted by a rotatable (circularly movable) endless belt. In addition, the fixing device 30 includes the pressing pad (fixing pad) 320 as a fixing member. In addition, the fixing device 30 includes a stay 360 which supports the pressing pad 320. In addition, the fixing device 30 includes the heating roller 340 as a heating member which also serves as a stretching roller. In addition, the fixing device 30 includes a steering roller 350 as the stretching roller. In addition, the fixing device 30 includes a heater 340a as a heating source disposed in an inside (a hollow portion) of the heating roller 340. In addition, the fixing device 30 includes a temperature sensor 392 as a temperature detecting means for detecting a temperature of the heating roller 340. A heating unit 300 is constituted by the fixing belt 310, the pressing pad 320, the stay 360, the heating roller 340, the steering roller 350, the heater 340a, the temperature sensor 392, etc. In addition, the fixing device 30 includes the pressing roller 330 as a pressing rotatable member (pressing member) disposed facing the fixing belt 310.

The fixing belt 310 is a member having a thin cylindrical shape with thermal conductivity and heat resistance. In the present Embodiment, the fixing belt 310 has a three-layer structure including a base layer, an elastic layer formed on an outer periphery of the base layer, and a releasing layer formed on an outer periphery of the elastic layer. In the present Embodiment, a polyimide resin (PI) is used as material for the base layer. In addition, in the present Embodiment, a silicone rubber is used as material for the elastic layer. In addition, in the present Embodiment, PFA (tetrafluoroethylene perfluoroalkoxyethylene copolymerization resin), which is a fluororesin, is used as material for the releasing layer. The fixing belt 310 is stretched by the pressing pad 320, the heating roller 340, and the steering roller 350.

The pressing pad 320 is pressed against the pressing roller 330 across the fixing belt 310. The pressing pad 320 is supported by the stay 360. In the present Embodiment, as material for the pressing pad 320, LCP (liquid crystal polymer), which is material having heat resistance, is used. In addition, in the present Embodiment, between the pressing pad 320 and the fixing belt 310, a lubricating sheet 370 as a sliding member is interposed. In the present Embodiment, as the lubricating sheet 370, a sheet formed of PI (polyimide) coated with PTFE (polytetrafluoroethylene) is used. In the present Embodiment, a thickness of the lubricating sheet 370 is 100 μm. In addition, in the present Embodiment, on the lubricating sheet 370, on a surface contacting the fixing belt 310, with intervals of 1 mm, projected shapes each having a diameter of approximately 100 μm is formed, and sliding resistance of the lubricating sheet 370 is reduced by reducing a contact area with the fixing belt 310. In addition, on an inner peripheral surface side of the fixing belt 310, an oil applying roller 393 as an oil applying member is disposed so as to contact the inner peripheral surface of the fixing belt 310. In the present Embodiment, the oil applying roller 393 is formed by silicone oil being impregnated into a member having a roll shape, around which nonwoven fabric (felt) having a thickness of 100 μm is wound. The oil applying roller 393 applies a lubricant to the inner peripheral surface of the fixing belt 310. As a result, the fixing belt 310 smoothly slides against the pressing pad 320 via the sliding sheet 370. In the present Embodiment, as the lubricant, silicone oil is used. Incidentally, the oil applying member is not limited to a roller, but may be any member which can apply the oil to the inner peripheral surface of the fixing belt 310. For example, as the oil applying member, a member which does not rotate but is disposed at a fixed position with respect to the inner peripheral surface of the fixing belt 310 may be used.

The stay 360 is a member which supports the pressing pad 320, and is constituted by a hollow pipe (tubular member). In the present Embodiment, the stay 360 is formed of a square pipe made of SUS (stainless steel). The stay 360 is supported by a heating unit frame (not shown) which is one of frames constituting the fixing device 30. The stay 360 and the pressing pad 320 are contacting each other.

The heating roller 340 is a member which heats the fixing belt 310, and is formed of a hollow pipe (tubular member). In the present Embodiment, the heating roller 340 is formed of a pipe (circular tube) made of SUS (stainless steel) having a thickness of 1 mm. The heating roller 340 is rotatably supported by the heating unit frame (not shown) which is one of the frames constituting the fixing device 30. The rotational axis direction of the heating roller 340 is approximately parallel to the rotational axis direction of the photosensitive drum 11. In the inside (hollow portion) of the heating roller 340, the heater 340a constituted by a halogen heater is disposed. The heater 340a is capable of heating the heating roller 340. The fixing belt 310 is heated by the heating roller 340. The temperature of the heating roller 340 is detected by the temperature sensor 392 constituted by a thermistor which is a temperature detecting element. The control portion 5 controls, based on a detection result of the temperature of the heating roller 340 by the temperature sensor 392, heat generation with the heater 340a so that the temperature of the heating roller 340 becomes a predetermined target temperature corresponding to the type of the recording material P. The temperature sensor 392 is disposed so as to contact an outer peripheral surface of the heating roller 340.

The steering roller 350 is rotatable (tiltable), about a rotational (pivotal) axis positioned at one end portion side or in a vicinity of a center in a rotational axis direction thereof, so that a rotational axis direction of the steering roller 350 is inclined with respect to the rotational axis direction of the heating roller 340. The steering roller 350 is tiltably supported by the heating unit frame (not shown) which is one of the frames constituting the fixing device 30. The steering roller 350 is tilted by a steering mechanism M3. As a result, the steering roller 350 generates a difference in tension between the front side and the rear side of the fixing belt 310, and controls a position of the fixing belt 310 in the Y direction (widthwise direction of the recording material P). In the present Embodiment, the steering roller 350 is formed of a hollow roller (shaft) made of SUS (stainless steel). Incidentally, in order to increase grip force with respect to the fixing belt 310, a surface layer constituted by rubber material, etc. may be provided to a surface of the steering roller 350. In a vicinity of the fixing belt 310, a belt position detecting portion 394 as a contact portion is provided, and the position of the fixing belt 310 in the Y direction is detected by the belt position detecting portion 394. The control portion 5 controls, based on a detection result of the position of the fixing belt 310 in the Y direction by the belt position detecting portion 394, the steering mechanism M3 so that the position of the fixing belt 310 in the Y direction is at a predetermined position. The steering roller 350 is urged by a spring supported by the heating unit frame (not shown) which is one of the frames constituting the fixing device 30, and also functions as a tension roller which applies a predetermined tensile force to the fixing belt 310.

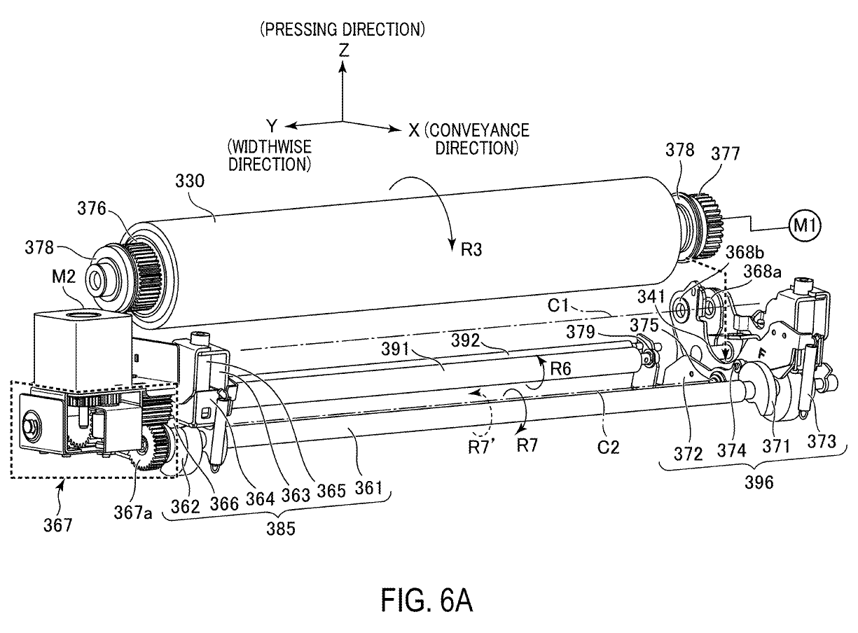

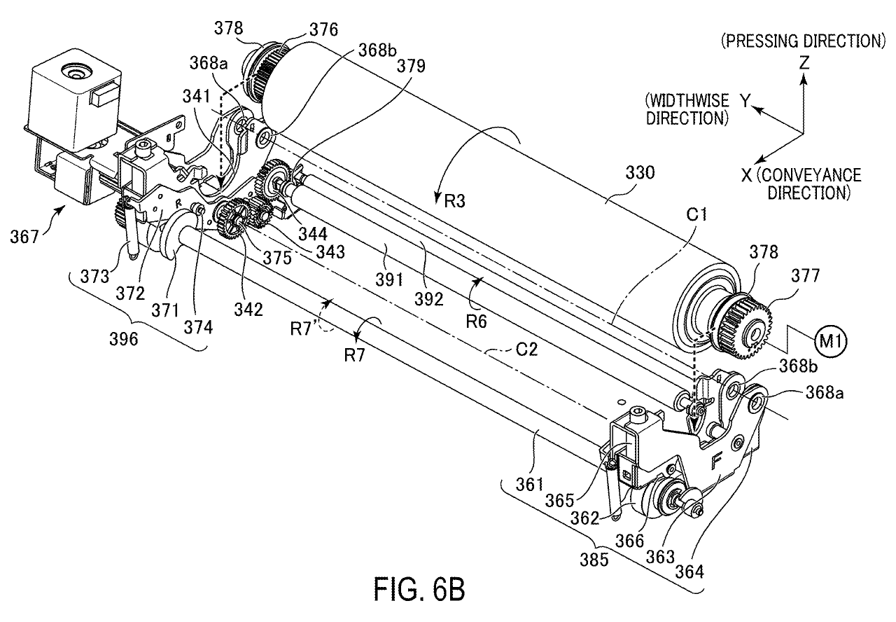

The pressing roller 330 is a roller having a core metal layer, an elastic layer formed on an outer periphery of the core metal layer, and a releasing layer formed on an outer periphery of the elastic layer. In the present Embodiment, the core metal layer is formed of a pipe (tubular member) made of SUS (stainless steel). In addition, in the present Embodiment, the elastic layer has a thickness of 5 mm, and electroconductive silicone rubber is used as material thereof. In addition, in the present Embodiment, the releasing layer has a thickness of 100 μm, and PFA (tetrafluoroethylene perfluoroalkoxyethylene copolymerization resin), which is fluororesin, is used as material thereof. The pressing roller 330 is rotatably supported by a pressing upper arm 363, which is movably supported by a fixing frame (pressing roller supporting frame) 380 which is one of the frames constituting the fixing device 30. The rotational axis direction of the pressing roller 330 is approximately parallel to the rotational axis direction of the photosensitive drum 11 and the heating roller 340. In the pressing roller 330, a pressing roller gear 377 (FIGS. 6A and 6B) is fixed to one end portion in the rotational axis direction thereof, and the pressing roller 330 is connected to a fixing driving motor M1 as a fixing rotatable member driving portion (driving source) via this pressing roller gear 377. And the pressing roller 330 is rotationally driven, by a driving force transmitted from the fixing driving motor M1, in a direction of an arrow R3 (counterclockwise direction) in FIG. 2. The pressing roller 330 is in contact with the pressing pad 320 across the fixing belt 310 (and even the sliding sheet 370), and forms a fixing nip portion (fixing portion) N together with the fixing belt 310. The fixing belt 310 is rotated (circularly moved), by being nipped between the pressing roller 330 and the pressing pad 320, in a direction of an arrow R4 (clockwise direction) in FIG. 2, driven by the rotation of the pressing roller 330 . In addition, the pressing upper arm 363, etc. constitute a pressing roller separating/contacting mechanism 385 (FIGS. 6A and 6B) as a pressing rotatable member separating/contacting means. The pressing roller separating/contacting mechanism 385 is configured to be movable so as to cause the pressing roller 330 to be contacted or separated with respect to the fixing belt 310 (be in contact with or separated from the pressing pad 320).

To the fixing frame 380, which is one of the frames constituting the fixing device 30, a heating unit positioning portion 381, the pressing upper arm 363, a pressing spring 365, etc. are attached. The stay 360 of the heating unit 300 is inserted into the heating unit positioning portion 381, and the stay 360 is fixed to the heating unit positioning portion 381 by an arbitrary fixing means such as a fastening member. After the stay 360 is fixed, by the pressing upper arm 363 being moved by the pressing roller separating/contacting mechanism 385, the pressing roller 330 is pressed against the pressing pad 320 across the fixing belt 310.

The fixing device 30 heats the toner image on the recording material P, in the fixing nip portion N formed between the fixing belt 310 and the pressing roller 330, while nipping and conveying the recording material P carrying the toner image, and fixes the toner image to the recording material P. For example, a pressing force in the fixing nip portion N during the fixing operation may be set to 1600 N. In addition, for example, a width of the fixing nip portion N in the X direction (conveyance direction of the recording material P) during the fixing operation may be set to 20 mm, and a width of the fixing nip portion N in the Y direction (widthwise direction of the recording material P) during the fixing operation may be set to 350 mm.

### Refreshing roller

In the present Embodiment, the fixing device 30 includes a belt refreshing roller 390 and a pressing refreshing roller 391 which are rubbing rotatable members having roller shapes as rubbing members (polishing members), and rub the heating rotatable member and the pressing rotatable member as fixing rotatable members, respectively. The belt refreshing roller 390 is in contact with an outer peripheral surface of the fixing belt 310. In the present Embodiment, the belt refreshing roller 390 is rotationally driven, so as to be moved in a forward direction with the fixing belt 310 at a contacting portion with the fixing belt 310, in a direction of an arrow R5 (counterclockwise direction) in FIG. 2 with a predetermined peripheral speed difference to the fixing belt 310. By this, an ability of the belt refreshing roller 390 to adjust (smooth) a surface state of the fixing belt 310 is enhanced. In addition, the pressing refreshing roller 391 is in contact with an outer peripheral surface of the pressing roller 330. In the present Embodiment, the pressing refreshing roller 391 is rotationally driven, so as to be moved in a forward direction with the pressing roller 330 at a contacting portion with the pressing roller 330, in a direction of an arrow R6 (clockwise direction) in FIG. 2 with a predetermined peripheral speed difference relative to the pressing roller 330. By this, an ability of the pressing refreshing roller 391 to adjust (smooth) a surface state of the pressing roller 330 is enhanced.

Incidentally, the belt refreshing roller 390 may be rotationally driven so as to be moved in an opposite direction to the moving direction of the fixing belt 310 at the contacting portion with the fixing belt 310. Also by this, the ability of the belt refreshing roller 390 to adjust (smooth) the surface state of the fixing belt 310 may be enhanced. In addition, the pressing refreshing roller 391 may be rotationally driven so as to be moved in an opposite direction to the moving direction of the pressing roller 330 at the contacting portion with the pressing roller 330. Also by this, the ability of the pressing refreshing roller 391 to adjust (smooth) the surface state of the pressing roller 330 may be enhanced.

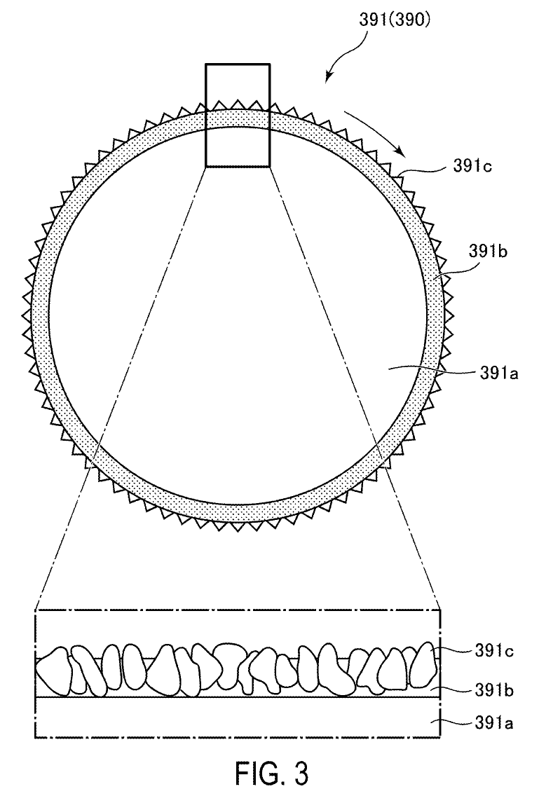

FIG. 3 is a schematic cross-sectional view illustrating a configuration of the belt refreshing roller 390 and the pressing refreshing roller 391. In the present Embodiment, the configuration of the belt refreshing roller 390 and the configuration of the pressing refreshing roller 391 are substantially the same. Here, the configuration of the pressing refreshing roller 391 will be further described as an example. As shown in FIG. 3, the pressing refreshing roller 391 is formed by abrasive grains 391c being densely adhered on a surface of a core metal 391a made of SUS (stainless steel) having a diameter of 12 mm via an adhesive layer 391b. The abrasive grain 391c may be appropriately selected from those of #1000 - (through) #4000, for example, depending on a purpose (target glossiness of an image). Incidentally, as for a numerical range, "- (through)" indicates a range including numerical values before and after "- (through)". An average particle diameter of the abrasive grains 391c is about 16 μm in a case of #1000, and is about 3 μm in a case of #4000. As the abrasive grain 390c, an alumina-based grain (commonly called "alundum" or "morundum") may suitably be used. The alumina-based abrasive grain is an abrasive grain which is most widely used industrially, of which hardness is much higher compared to the surfaces of the fixing belt 310 and the pressing roller 330, and particles thereof have shapes having acute angles, so that the alumina-based abrasive grain are excellent in roughening performance (refreshing performance, smoothing performance).

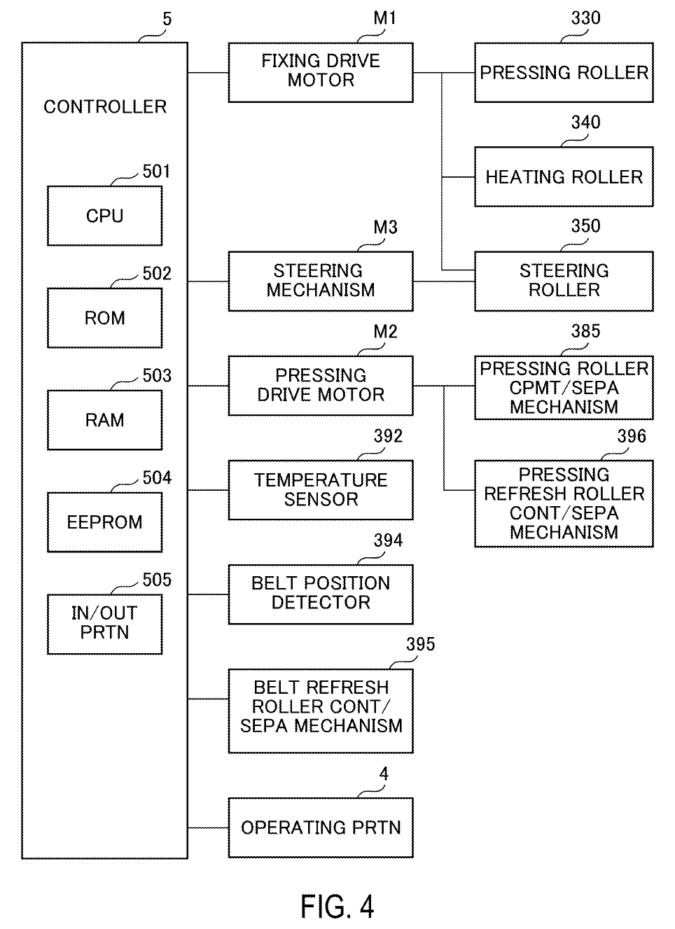

The belt refreshing roller 390 is caused, by a belt refreshing roller separating/contacting mechanism 395 (FIG. 4) as a rubbing rotatable member separating/contacting means, to be in contact with and separated from the fixing belt 310. The belt refreshing roller separating/contacting mechanism 395 urges the belt refreshing roller 390 toward the fixing belt 310 by an urging force of a spring, and applies a predetermined pressure to the fixing belt 310. As a result, between the belt refreshing roller 390 and the fixing belt 310, a rubbing nip portion (not shown) having a predetermined width in the rotational direction of the fixing belt 310 is formed. The belt refreshing roller 390 is rotationally driven, and the speed difference is set between a rotation speed of the fixing belt 310 and a rotation speed of the belt refreshing roller 390. Therefore, the belt refreshing roller 390 rubs the fixing belt 310 in the rubbing nip portion.

The pressing refreshing roller 391 is caused, by a pressing refreshing roller separating/contacting mechanism 396 (FIGS. 2, 4) as a rubbing rotatable member separating/contacting means, to be in contact with and separated from the pressing roller 330. The pressing refreshing roller separating/contacting mechanism 396 will be described below.

### Control configuration of the image forming apparatus

Next, a control configuration of the image forming apparatus 1 in the present Embodiment will be described. FIG. 4 is a block diagram illustrating an outline control configuration of the image forming apparatus 1 in the present Embodiment.

The image forming apparatus 1 includes the control portion 5 as a control means which comprehensively controls the image forming apparatus 1. The control portion 5 is configured to include a CPU 501 as an arithmetic process means (arithmetic process portion), a ROM 502, a RAM 503, and an EEPROM (non-volatile memory) 504 as storage means (storage portions), and an input/output portion (input/output circuit) 505 as an input/output means. The CPU 501 performs the control of the image forming apparatus 1. In the ROM 502, a control program, an application program, etc. which are executed by the CPU 501 are stored. The RAM 503 functions as a working area for executing processes of the control program, and detection results of various types of sensors and arithmetic results are temporarily saved therein. The EEPROM 504 keeps data such as various types of settings, which are desired to be kept even when power of the image forming apparatus 1 is turned off. The input/output portion 505 is used for performing input/output of information (signal) between the control portion 5 and various types of devices outside the control portion 5.

To the control portion 5, each portion of the image forming apparatus 1 is connected. For example, to the control portion 5, various types of driving portions such as the fixing driving motor M1 and a pressing driving motor M2, which will be described below, are connected. The fixing driving motor M1 generates the driving force for rotating the pressing roller 330, and the driving force transmitted to the pressing roller 330 is transmitted to the heating roller 340 and the steering roller 350 via the fixing belt 310. The pressing driving motor M2 generates a driving force for operating the pressing roller separating/contacting mechanism 385 and the pressing refreshing roller separating/contacting mechanism 396, as will be described below in detail. In addition, to the control portion 5, the steering mechanism M3, which tilts the steering roller 350, is connected. In addition, to the control portion 5, the belt refreshing roller separating/contacting mechanism 395 is connected. Operations of the fixing driving motor M1, the pressing driving motor M2, the steering mechanism M3, and the belt refreshing roller separating/contacting mechanism 395 are controlled based on control signals from the control portion 5, respectively. In addition, to the control portion 5, various types of sensors such as the temperature sensor 392 and the belt position detecting portion 394 are connected. The temperature sensor 392 and the belt position detecting portion 394 output signals indicating the detection results thereof toward the control portion 5, respectively.

In addition, to the control portion 5, an operating portion (UI) 4 provided to the image forming apparatus 1 is connected. The operating portion 4 is configured to include a display portion, which performs display of information to a user (an operator) through the control by the control portion 5, and an input portion, which inputs information such as the various types of settings to the control portion 5 based on an operation by a user. The operating portion 4 may be configured to include a touch panel, etc. having the function of the display portion and the function of the input portion. In this case, the operating portion 4 performs screen display to a user and receiving of a touch input by a user.

The control portion 5 controls the operations of the respective portions of the image forming apparatus 1 based on print information received from the operating portion 4 and the external host device, and controls the image forming apparatus 1 so as to execute a job. The print information includes a start instruction for a print, various types of settings on the print (for example, the type of the recording material P, a number of copies to be printed), etc. The job is a series of operations which is started by one start instruction and through which the image is formed and output on a single or a plurality of the recording material P.

Incidentally, the control portion 5, which also controls the respective portions of the fixing device 30, may also be regarded as a portion constituting the fixing device 30.

### Outline of a refreshing mode

Next, a refreshing mode (refreshing operation) will be described. The belt refreshing roller 390 and the pressing refreshing roller 391 may be operated independently of each other. In other words, the belt refreshing roller 390 is capable of contacting and separating with respect to the fixing belt 310 independently of a separating/contacting operation for the pressing refreshing roller 391 with respect to the pressing roller 330. Similarly, the pressing refreshing roller 391 is capable of contacting and separating with respect to the pressing roller 330 independently of the separating/contacting operation for the belt refreshing roller 390 with respect to the fixing belt 310. Therefore, the belt refreshing roller 390 and the pressing refreshing roller 391 may individually contact and separate with respect to the fixing belt 310 and the pressing roller 330. The control portion 5 operates, at an appropriate timing, the belt refreshing roller separating/contacting mechanism 395 and the pressing refreshing roller separating/contacting mechanism 396, and controls a start timing and an end timing of a fixing belt refreshing mode, and a start timing and an end timing of a pressing roller refreshing mode.

The control portion 5 may control an execution timing of the fixing belt refreshing mode based on a count value of a counter. In addition, the control portion 5 may control an execution timing of the pressing roller refreshing mode based on the count value of the counter. For example, the control portion 5 may count a number of recording material P which has passed through the fixing device 30 (number of passed sheets) using the EEPROM 504 as a passed sheet counter. In addition, for example, the control portion 5 may count an index value which indicates changes in the respective surface states of the fixing belt 301 and the pressing roller 330 using the EEPROM 504 as a surface state counter. The counter stores the count value for each of the fixing belt refreshing mode and the pressing roller refreshing mode. Incidentally, each count value may be calculated and counted depending on a size, the type, the number of passed sheets, and a fixing temperature of the recording material P supplied to the fixing device 30. And if the count value satisfies a predetermined condition, then the control portion 5 controls so as to execute each refreshing mode at a predetermined timing which is, in the present Embodiment, at a timing during which the recording material P is not supplied to the fixing device 30. For example, if the count value of the counter for the fixing belt refreshing mode exceeds a predetermined threshold value set in advance for the fixing belt refreshing mode, then the control portion 5 controls so as to execute the fixing belt refreshing mode. And if the fixing belt refreshing mode is executed, then the control portion 5 resets the count value of the counter for the fixing belt refreshing mode to an initial value (for example, zero). In addition, for example, if the count value of the counter for the pressing roller refreshing mode exceeds a predetermined threshold value set in advance for the pressing roller refreshing mode, then the control portion 5 controls so as to execute the pressing roller refreshing mode. And if the pressing roller refreshing mode is executed, then the control portion 5 resets the count value of the counter for the pressing roller refreshing mode to an initial value (for example, zero).

By executing the fixing belt refreshing mode and causing the belt refreshing roller 390 to be in contact with the fixing belt 310, it becomes possible to recover the surface state of the fixing belt 310. In addition, by executing the pressing roller refreshing mode and causing the pressing refreshing roller 391 to be in contact with the pressing roller 330, it becomes possible to recover the surface state of the pressing roller 330. In the present Embodiment, during execution of each refreshing mode, the supply of the recording material P to the fixing device 30 (in other words, image formation) is temporarily stopped. Each refreshing mode may be executed in a state in which the pressing roller 330 is separated from the fixing belt 310, or may be executed in a state in which the pressing roller 330 is in contact with the fixing belt 310.

### Changes in the surface states of the fixing belt and the pressing roller

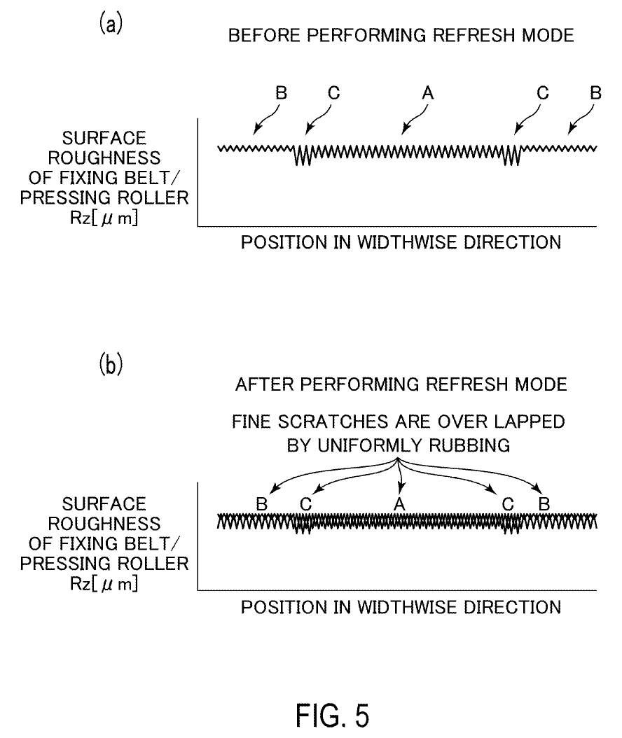

Using FIG. 5, a surface state of a processed surface before and after the execution of the refreshing mode will be described. Part (a) of FIG. 5 is a graph view showing the surface states of the fixing belt 310 and the pressing roller 330 before the execution of the fixing belt refreshing mode and the pressing roller refreshing mode. Part (b) of FIG. 5 is a graph view showing the surface states of the fixing belt 310 and the pressing roller 330 after the execution of the fixing belt refreshing mode and the pressing roller refreshing mode. In part (a) and part (b) of FIG. 5, a horizontal axis represents a position in the Y direction (the widthwise direction of the recording material P), and a vertical axis represents surface roughness. Incidentally, a tendency in a change in the surface state of the processed surface (surface of the fixing belt 310) before and after the execution of the fixing belt refreshing mode, and a tendency in a change in the surface state of the processed surface (surface of the pressing roller 330) before and after the execution of the pressing roller refreshing mode are substantially the same. Here, the surface state of the pressing roller 330 before and after the execution of the pressing roller refreshing mode will be described as an example.

As shown in part (a) of FIG. 5, before the execution of the refreshing mode, on the surface of the pressing roller 330 in areas C, through which edges the recording material P of a small size passes, steps are formed due to the edges (paper edges) of the recording material P. Here, the recording material P of a small size is a recording material P of a predetermined size, of which a width in the Y direction is smaller than a width in the Y direction of the recording material P of maximum size, up to which the fixing device 30 can heat the image thereon. Incidentally, an area A is an area through which this recording material P of the small size passes (sheet passing area), and areas B are areas through which the recording material P of the small size does not pass (non-sheet passing area). With the surface state as shown in part (a) of FIG. 5, at positions corresponding to step portions in the areas C, streaks (unevenness in gloss) may appear in the image after fixing.

To the contrary, by the refreshing mode being executed, the surface of the pressing roller 330 in the areas A, B, and C is uniformly rubbed by the abrasive grains of #1000 through #4000. As a result, as shown in part (b) of FIG. 5, after the execution of the refreshing mode, by fine rubbing scratches being overlapped, differences in the surface state (roughened state) of the pressing roller 330 in the areas A, B, and C become small. As a result, the streak on the image after fixing caused by the difference (step) in the roughened state of the surface of the pressing roller 330 becomes inconspicuous, and the streak on the image is greatly improved.

### Configurations of the pressing roller separating/contacting mechanism and the pressing refreshing roller separating/contacting mechanism

Next, configurations of the pressing roller separating/contacting mechanism 385 and the pressing refreshing roller separating/contacting mechanism 396 in the present Embodiment will be described. Hereinafter, the pressing refreshing roller, the pressing refreshing roller separating/contacting mechanism, and the pressing roller refreshing mode are also simply referred to as a "refreshing roller", a "refreshing roller separating/contacting mechanism", and a "refreshing mode", respectively.

The pressing roller separating/contacting mechanism 385 can move the pressing roller 330 to a contact position, at which the pressing roller 330 is in contact with the fixing belt 310, and a separated position, at which the pressing roller 330 is separated from the fixing belt 310. In addition, the refreshing roller separating/contacting mechanism 396 can move the refreshing roller 391 to a contact position, at which the refreshing roller 391 is in contact with the pressing roller 330, and a separated position, at which the refreshing roller 391 is separated from the pressing roller 330. FIG. 6A is a perspective view illustrating a state of the pressing roller separating/contacting mechanism 385 and the refreshing roller separating/contacting mechanism 396 as viewed from a downstream side of the pressing roller 330 in the conveyance direction of the recording material P (X direction) and the rear side. FIG. 6B is a perspective view illustrating a state of the pressing roller separating/contacting mechanism 385 and the refreshing roller separating/contacting mechanism 396 as viewed from the downstream side of the pressing roller 330 in the conveyance direction of the recording material P and the front side.

As shown in FIGS. 6A and 6B, the pressing roller separating/contacting mechanism 385 is configured to include a cam shaft 361, a pressing cam 362, the pressing upper arm 363, a pressing lower arm 364, the pressing spring 365, and a pressing cam follower 366. The cam shaft 361 extends approximately parallel to the rotational axis direction of the pressing roller 330 (Y direction), and is rotatably supported by the fixing frame 380 (FIG. 2). The pressing cams 362 are fixed to both end portions in a rotational axis direction of the cam shaft 361, respectively. The pressing upper arm 363 as a first supporting member and the pressing lower arm 364 as a moving member, which moves the pressing upper arm 363, are supported by the fixing frame 380 rotatably (swingably) about a first rotational axis C1, which is approximately parallel to the rotational axis of the pressing roller 330, respectively. More specifically, the pressing upper arm 363 and the pressing lower arm 364 are attached to the fixing frame 380 rotatably about the first rotational axis C1 by a pressing arm rotatable shaft 369, which is provided to the fixing frame 380, being passed through rotation holes 368a and 368b, which are provided to the pressing upper arm 363 and the pressing lower arm 364, respectively. Pairs of the pressing upper arm 363 and the pressing lower arm 364 are provided on both end portion sides in the rotational axis direction of the pressing roller 330, respectively. The pressing spring 365, which is constituted by a compression coil spring and is an urging member as an urging means, is disposed between the pressing upper arm 363 and the pressing lower arm 364. The pressing spring 365 is disposed, in the conveyance direction of the recording material P, on the downstream side of the first rotational axis C1. To the respective pressing upper arms 363, supporting portions 341 for supporting bearings 378, which are provided at both end portions in the rotational axis direction of the pressing roller 330, are provided, respectively. The supporting portion 341 is disposed, in the conveyance direction of the recording material P, on the downstream side of the first rotational axis C1 and on an upstream side of the pressing spring 365 (and the pressing cam follower 366). The pressing cam follower 366 is constituted by a roller, and is rotatably supported by the pressing lower arm 364. The pressing cam follower 366 is disposed, in the conveyance direction of the recording material P, on the downstream side of the first rotational axis C1.

Details will be described below, however, by the cam shaft 361 being rotated, the pressing cam 362 pushes up the pressing lower arm 364 via the pressing cam follower 366 in a direction approaching the fixing belt 310. Then the pressing upper arm 363, which is connected to the pressing lower arm 364 by the pressing spring 365, is pushed up in the direction approaching the fixing belt 310. As a result, the pressing roller 330, which is supported by the pressing upper arm 363 via the bearing 378, is pushed up in the direction approaching the fixing belt 310, and comes in contact with the fixing belt 310. In addition, by the pressing lower arm 364 being further pushed up, the pressing spring 365 is compressed, and the pressing upper arm 363 is urged in the direction toward the fixing belt 310 by an elastic force of the pressing spring 365. As a result, the pressing roller 330 is pressed toward the fixing belt 310 (pressing pad 320).

As shown in FIGS. 6A and 6B, the refreshing roller separating/contacting mechanism 396 is configured to include the cam shaft 361, a refreshing cam 371, a refreshing arm 372, a refreshing spring 373, and a refreshing cam follower 374. In the present Embodiment, the cam shaft 361 is shared by the pressing roller separating/contacting mechanism 385 and the refreshing roller separating/contacting mechanism 396, and is a shaft which constitutes the pressing roller separating/contacting mechanism 396 and also is a shaft which constitutes the refreshing roller separating/contacting mechanism 396. The refreshing cams 371 are fixed to both end portions of the cam shaft 361 in the rotational axis direction thereof, respectively. The refreshing arm 372 as a second supporting member is supported, rotatably (swingably) about a second rotational axis C2 approximately parallel to the rotational axis of the pressing roller 330, by the pressing upper arm 363. More specifically, the refreshing arm 372 is attached, by a rotatable shaft 375 provided to the pressing upper arm 363 being passed through a rotation hole (not shown) provided to the refreshing arm 372, to the rotatable shaft 375 rotatably. The refreshing arm 372 is attached to the respective pressing upper arms 363. Of the refreshing spring 373 constituted by a tension coil spring, which is an urging member as an urging means, one end portion is engaged with the refreshing arm 372, and the other end portion is engaged with the fixing frame 380. The refreshing spring 373 is disposed, in the conveyance direction of the recording material P, on the downstream side of the second rotational axis C2. To the respective refreshing arms 372, refreshing supporting portions 379 for rotatably supporting the refreshing roller 391 are provided, respectively. The refreshing supporting portion 379 is disposed, in the conveyance direction of the recording material P, on the upstream side of the second rotational axis C2. The refreshing cam follower 374 is constituted by a roller, and is rotatably supported by the refreshing arm 372. The refreshing cam follower 374 is disposed, in the conveyance direction of the recording material P, on the downstream side of the second rotational axis C2.

Details will be described below, however, the refreshing arm 372 is urged, by the refreshing spring 373, in a direction in which the refreshing roller 391 supported by the refreshing arm 372 comes into contact with the pressing roller 330. As a result, the refreshing roller 391 is pressed toward the pressing roller 330. When the cam shaft 361 is rotated and the refreshing cam 371 pushes up the refreshing arm 372 via the refreshing cam follower 374 in the direction approaching the pressing roller 330, the refreshing arm 372 is rotated against an elastic force of the refreshing spring 373. As a result, the refreshing roller 391, which is supported by the refreshing arm 372, is moved in a direction separated from the pressing roller 330. As a result, the refreshing roller 391 is separated from the pressing roller 330.

In addition, as shown in FIG. 6B, to the rotatable shaft 375, which is provided to the pressing upper arm 363 on one end portion side in the rotational axis direction of the pressing roller 330, which is the rear side in the present Embodiment, a first idler gear (drive receiving gear) 342 as a drive transmission member is rotatably attached. More specifically, the first idler gear 342 is attached, by the rotatable shaft 375 being passed through a rotation hole (not shown) provided to the first idler gear 342, to the rotatable shaft 375 rotatably. To this rotatable shaft 375, as described above, the refreshing arm 372 is also rotatably attached. In addition, to the refreshing arm 372 on the rear side, a second idler gear 343 is rotatably provided so as to be meshed with the first idler gear 342. And this second idler gear 343 is meshed with a refreshing gear (driving gear) 344 as a driving member, which is provided to an end portion on the rear side of the refreshing roller 391 supported by the refreshing arm 372.

On the other hand, to one end portion in the rotational axis direction of the pressing roller 330, which is an end portion on the rear side in the present Embodiment, a drive input gear 376 as a drive input member is provided. The drive input gear 376 is provided, in the rotational axis direction of the pressing roller 330, on a center side of the pressing roller 330 relative to the bearing 378 on the rear side. Upon the bearing 378 of the pressing roller 330 being set to the supporting portion 341 of the pressing upper arm 363, the drive input gear 376, which is provided to the pressing roller 330, is meshed with the first idler gear 342, which is attached to the rotatable shaft 375 provided to the pressing upper arm 363. As a result, from the drive input gear 376, via the first idler gear 342 and the second idler gear 343, to the refreshing gear 344, all are drive-connected, and it becomes possible for the rotation of the pressing roller 330 to be transmitted to the refreshing roller 391. When the pressing roller 330 is rotated, the refreshing roller 391 is also rotated, and when the rotation of the pressing roller 330 is stopped, the rotation of the refreshing roller 391 is also stopped.

In addition, as described above, to the other end portion in the rotational axis direction of the pressing roller 330, which is an end portion on the front side in the present Embodiment, the pressing roller gear 377 is provided. The pressing roller gear 377 is connected to the fixing driving motor M1 via a gear train (not shown). And the pressing roller 330 is rotationally driven by the driving force transmitted from the fixing driving motor M1. In the refreshing mode, the fixing driving motor M1 is driven at a predetermined speed (refreshing speed). As a result, the pressing roller 330 is rotated in a direction of an arrow R3 in FIGS. 6A and 6B at a peripheral speed of 400 mm/s, and the refreshing roller 391 is rotated in a direction of an arrow R6 in FIGS. 6A and 6B at a peripheral speed of 200 mm/s. So as the refreshing roller 391 to be rotated under the condition in this manner, gear ratios among the drive input gear 376, the first idler gear 342, the second idler gear 343, and the refreshing gear 344 are set.

As shown in FIGS. 6A and 6B, to one end portion of the cam shaft 361, which is the end portion on the rear side in the present Embodiment, a cam driving gear 367a is provided. The cam shaft 361 is connected, via a gear train 367 configured to include this cam driving gear 367a, to the pressing driving motor M2 as a separating/contacting mechanism driving portion (driving source). The pressing driving motor M2 rotationally drives the cam shaft 361, and operates the pressing roller separating/contacting mechanism 385 and the refreshing roller separating/contacting mechanism 396. Details will be described below, however, when the cam shaft 361 is rotated in a forward rotational direction (direction of an arrow R7 in FIGS. 6A and 6B), the pressing roller 330 is moved in a direction separated from the fixing belt 310. Conversely, when the cam shaft 361 is rotated in a reverse rotational direction (direction of an arrow R7' in FIGS. 6A and 6B), the pressing roller 330 is moved in a direction approaching the fixing belt 310.

Incidentally, in the present Embodiment, the refreshing arm 372 rotatably supports a cleaning roller 392 as a cleaning member. The cleaning roller 392 is provided so as to be in contact with the refreshing roller 391, and is rotated driven by the rotation of the refreshing roller 391. The cleaning roller 392 removes paper dust, etc. adhered to a surface of the refreshing roller 391 from the surface of the refreshing roller 391. In the present Embodiment, the cleaning roller 392 is constituted by a brush roller, in which a pile brush, in which a fiber bundle is flocked, is wound around a surface of a core metal made of metal such as SUS (stainless steel). Incidentally, the cleaning member is not limited thereto, but may be a sponge roller, etc. in which a sponge (elastic form member) layer is provided around the core metal. The cleaning roller 392 is supported by the refreshing arm 372, and is rotated (swung) integrally with the refreshing roller 391. Therefore, it is not necessary to provide a driving source, etc. for bringing the cleaning roller 392 into contact with the refreshing roller 391. Therefore, it becomes possible to dispose the cleaning roller 392 while saving space.

### Transitions of states of the pressing roller separating/contacting mechanism and the pressing refreshing roller separating/contacting mechanism

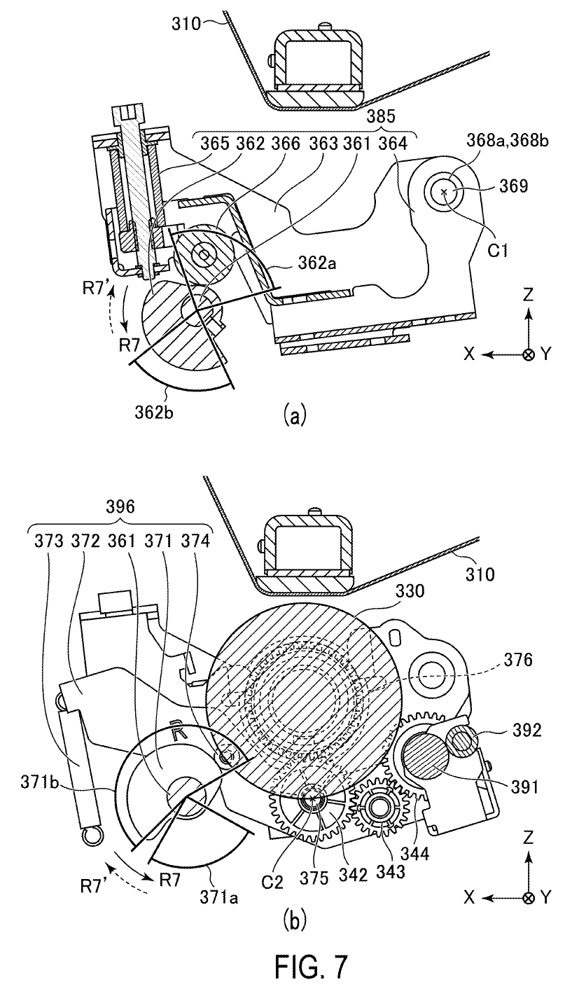

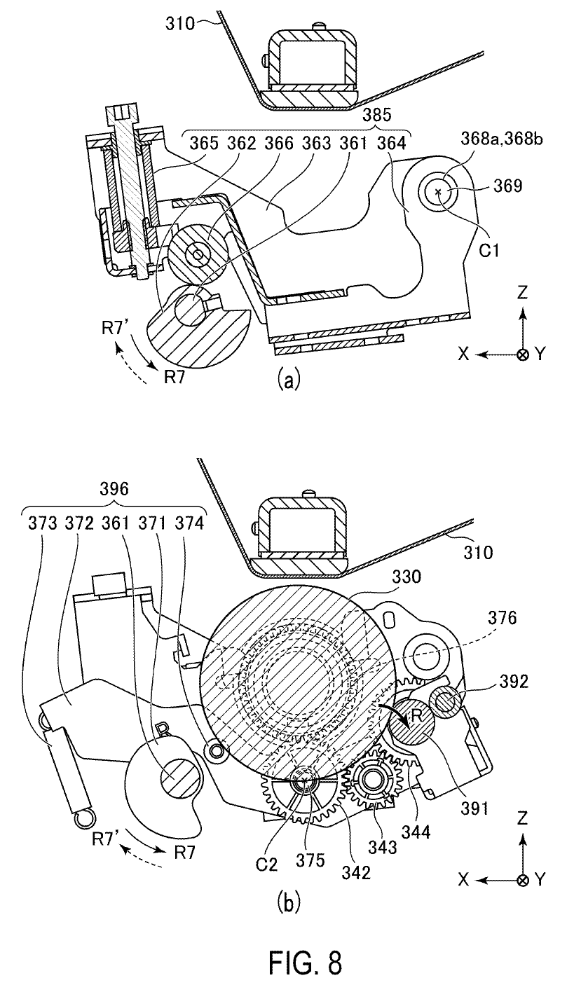

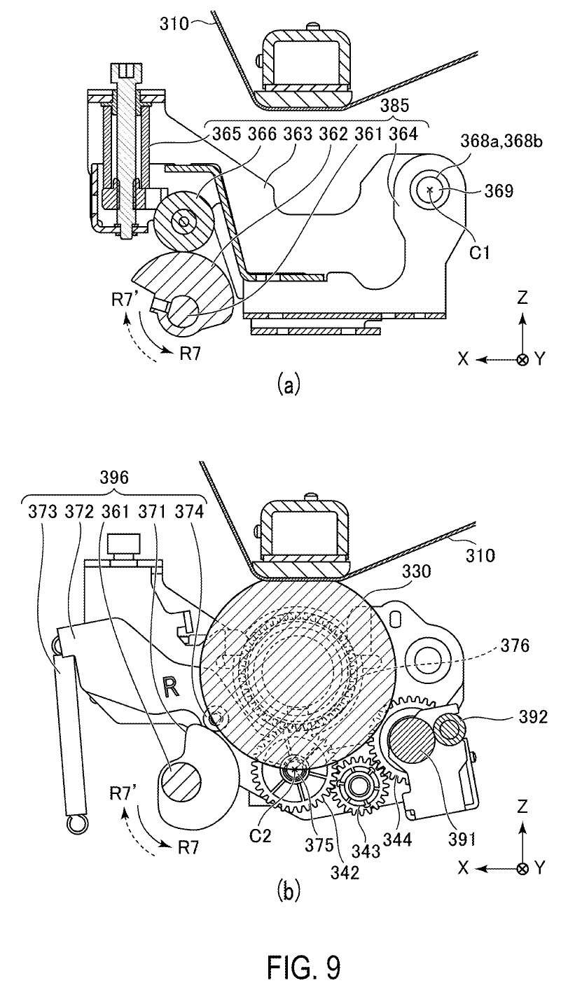

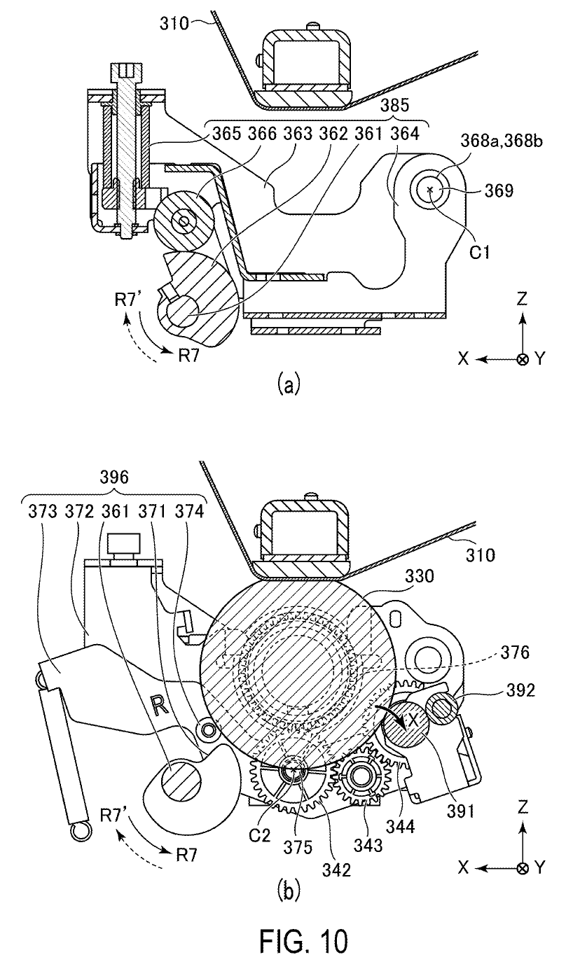

Next, transitions of states of the pressing roller separating/contacting mechanism 385 and the refreshing roller separating/contacting mechanism 396 will be described. FIGS. 7 and 8 are cross-sectional views illustrating states, when the pressing roller 330 is at the separated position, of the pressing roller separating/contacting mechanism 385 (part (a) of FIG. 7, part (b) of FIG. 8) and the refreshing roller separating/contacting mechanism 396 (part (b) of FIG. 7, part (b) of FIG. 8). Part (a) of FIG. 7 and part (b) of FIG. 7 illustrate states at the same timing, part (a) of FIG. 8 and part (b) of FIG. 8 illustrate states at the same timing, and FIGS. 7 and 8 illustrate states in which positions (phases) in the rotational direction of the cam shaft 361 are different. In addition, FIGS. 9 and 10 are cross-sectional views illustrating states, when the pressing roller 330 is at the contact position, of the pressing roller separating/contacting mechanism 385 (part (a) of FIG. 9, part (a) of FIG. 10) and the refreshing roller separating/contacting mechanism 396 (part (b) of FIG. 9, part (b) of FIG. 10). Part (a) of FIG. 9 and part (b) of FIG. 9 illustrate states at the same timing, part (a) of FIG. 10 and part (b) of FIG. 10 illustrate states at the same timing, and FIGS. 9 and 10 illustrate states in which the positions (phases) in the rotational direction of the cam shaft 361 are different.

As shown in part (a) of FIG. 7, the pressing cam 362 has a bottom dead point area 362a and a top dead point area 362b, which are areas in which rotational radii thereof are different. The rotational radius in the bottom dead point area 362a of the pressing cam 362 is smaller than the rotational radius in the top dead point area 362b of the pressing cam 362. In addition, as shown in part (b) of FIG. 7, the refreshing cam 371 has a bottom dead point area 371a and a top dead point area 371b, which are areas in which rotational radii thereof are different. The rotational radius in the bottom dead point area 371a of the refreshing cam 371 is smaller than the rotational radius in the top dead point area 371b of the refreshing cam 371.

Using FIGS. 7 and of 8, when the pressing roller 330 is at the separated position, the states (operations) of the pressing roller separating/contacting mechanism 385 and the refreshing roller separating/contacting mechanism 396 will be described.

First, the states shown in FIG. 7 will be described. As shown in part (a) of FIG. 7, the bottom dead point area 362a of the pressing cam 362 is in contact with the pressing cam follower 366. In this state, the pressing lower arm 364 is not pushed up by the pressing cam 362, so that the pressing roller 330 is separated from the fixing belt 310. In addition, as shown in part (b) of FIG. 7, the top dead point area 371b of the refreshing cam 371 is in contact with the refreshing cam follower 374. In this state, the refreshing arm 372 is pushed up by the refreshing cam 371, and is rotated in a clockwise direction in part (b) of FIG. 7, so that the refreshing roller 391 is separated from the pressing roller 330.

Next, the states shown in FIG. 8 will be described. FIG. 8, part (a) and part (b), illustrates states in which the cam shaft 361 is rotated in the forward rotational direction (a direction of an arrow R7 in FIG. 8) from the states shown in FIG. 7. As shown in part (a) of FIG. 8, the bottom dead point area 362a of the pressing cam 362 is still in contact with the pressing cam follower 366, so that the pressing roller 330 is separated from the fixing belt 310. On the other hand, as shown in part (b) of FIG. 8, when the bottom dead point area 371a of the refreshing cam 371 is moved to a position at which the bottom dead point area 371a faces the refreshing cam follower 374, the refreshing cam 371 is separated from the refreshing cam follower 374. As a result, the refreshing arm 372 is pulled by the refreshing spring 373, and is rotated in a counterclockwise direction in part (b) of FIG. 8, so that the refreshing roller 391 comes into contact with the pressing roller 330. In addition, in this state, the refreshing roller 391 receives the pressing force toward the pressing roller 330 from the refreshing spring 373. And the refreshing mode in the state in which the pressing roller 330 is separated from the fixing belt 310 is executed.

Here, in the states shown in part (a) and part (b) of FIG. 8, for example, in a case in which the pressing roller 330 is in a state of being thermally expanded by storing heat such as immediately after sheet passing, a distance between axes of the pressing roller 330 and the refreshing roller 391 may be widened more than a state in which the pressing roller 330 is not thermally expanded. In this case, the refreshing arm 372, which supports the refreshing roller 391, is rotated in a direction of an arrow R in part (b) of FIGURE(the clockwise direction in part (b) of FIG. 8) about the rotatable shaft 375. However, in the present Embodiment, the first idler gear 342 is attached to the rotatable shaft 375, to which the refreshing arm 372 is attached. Therefore, even in the case in which the refreshing arm 372 is rotated (swung), a distance between axes of the drive input gear 376, which is a drive connecting portion, and the first idler gear 342 is not changed. Similarly, in this case, a distance between axes of the first idler gear 342 and the second idler gear 343 is not changed. In addition, in this case, a distance between axes of the second idler gear 343 and the refreshing gear 344, which are swung integrally with the refreshing arm 372, is not changed, either. In this manner, in the present Embodiment, the first idler gear 342 is disposed so as to be rotated about the rotation center of the refreshing arm 372 (second rotational axis C2). Therefore, it becomes possible, in a state in which the distances between axes of the drive input gear 376 and the first idler gear 342, of the first idler gear 342 and the second idler gear 343, and of the second idler gear 343 and the refreshing gear are maintained, for the refreshing arm 372 to be rotated. Therefore, the drive connection from the drive input gear 376 to the refreshing gear 344 is not affected by the thermal expansion due to the heat storing state of the pressing roller 330.

Next, using part (a) and part (b) of FIG. 9 and part (a) and part (b) of FIG. 10, when the pressing roller 330 is at the contact position, the states (operations) of the pressing roller separating/contacting mechanism 385 and the refreshing roller separating/contacting mechanism 396 will be described.

First, the states shown in FIG. 9 will be described. By the cam shaft 361 being rotated in the reverse rotational direction (direction of arrows R7' in part (a) and part (b) of FIG. 7 ) from the states shown in FIG. 7, the states shown in FIG. 9 are achieved. As shown in part (a) of FIG. 9, the top dead point area 362b of the pressing cam 362 is in contact with the pressing cam follower 366. In this state, the pressing lower arm 364 is pushed up by the pressing cam 362, and is rotated in a clockwise direction in part (a) of FIG. 9, so that the pressing roller 330 is in contact with the fixing belt 310. In addition, in this state, the pressing roller 330 receives the pressing force toward the fixing belt 310 from the pressing spring 365. In addition, as shown in part (b) of FIG. 9, the top dead point area 371b of the refreshing cam 371 is in contact with the refreshing cam follower 374. In this state, the refreshing arm 372 is pushed up by the refreshing cam 371, and is rotated in a clockwise direction in part (b) of FIG. 9, so that the refreshing roller 391 is separated from the pressing roller 330.

Next, the states shown in FIG. 10 will be described. FIG. 10, part (a) and part (b), illustrates states in which the cam shaft 361 is rotated in the reverse rotational direction (a direction of arrows R7' in part (a) and part (b) of FIG. 9) from the states shown in FIG. 9. As shown in part (a) of FIG. 10, the top dead point area 362b of the pressing cam 362 is still in contact with the pressing cam follower 366, so that the pressing roller 330 is in contact with the fixing belt 310. On the other hand, as shown in part (b) of FIG. 10, when the bottom dead point area 371a of the refreshing cam 371 is moved to a position at which the bottom dead point area 371a faces the refreshing cam follower 374, the refreshing cam 371 is separated from the refreshing cam follower 374. As a result, the refreshing arm 372 is pulled by the refreshing spring 373, and is rotated in a counterclockwise direction in part (b) of FIG. 10, so that the refreshing roller 391 comes into contact with the pressing roller 330. In addition, in this state, the refreshing roller 391 receives the pressing force toward the pressing roller 330 from the refreshing spring 373. Then, the refreshing mode in the state in which the pressing roller 330 is in contact with the fixing belt 310 is executed.

Here, in the states shown in FIG. 10, in the case in which, for example, the pressing roller 330 is in a state in which a temperature thereof rises by receiving heat from a fixing belt 310, etc. and the pressing roller 330 is thermally expanded, the distance between axes of the pressing roller 330 and the refreshing roller 391 may be widened more than the state in which the pressing roller 330 is not thermally expanded. In this case, the refreshing arm 372, which supports the refreshing roller 391, is rotated in a direction of an arrow X in part (b) of FIG. 10 (clockwise direction in part (b) of FIG. 10) about the rotatable shaft 375. However, in the present Embodiment, similarly as described using FIG. 7 and FIG. 8, the first idler gear 342 is disposed so as to be rotated about the rotation center of the refreshing arm 372 (second rotational axis C2). Therefore, it becomes possible, in the state in which the distances between axes of the drive input gear 376 and the first idler gear 342, of the first idler gear 342 and the second idler gear 343, and of the second idler gear 343 and the refreshing gear are maintained, for the refreshing arm 372 to be rotated. Therefore, even in the case in which the pressing roller 330 is thermally expanded by receiving heat from the fixing belt 310, etc., the drive connection from the drive input gear 376 to the refreshing gear 344 is not affected.

As described above, in the present Embodiment, the fixing device 30 for heating the toner image on the recording material nipped and conveyed in the fixing nip portion N, and for fixing the toner image onto the recording material includes the fixing rotatable member (pressing roller) 330 which forms the fixing nip portion N, the first supporting member (pressing upper arm) 363 which supports the fixing rotatable member 330, the rubbing rotatable member (pressing refreshing roller) 391 which rubs the surface of the fixing rotatable member 330, the second supporting member (refreshing arm) 372 which supports the rubbing rotatable member 391 and is rotatable relative to the first supporting member 363 so as to move the rubbing rotatable member 391 between a first position (the contact position) where the rubbing rotatable member 391 is in contact with the fixing rotatable member 330 and a second position (the separated position) where the rubbing rotatable member 391 is separated from the fixing rotatable member 330, the separating/contacting mechanism (pressing refreshing roller separating/contacting mechanism) 396 which rotates the second supporting member 372, the drive input member (drive input gear) 376 provided coaxially with the fixing rotatable member 330 and which is rotated integrally with the fixing rotatable member 330, the driving member (refreshing gear) 344 provided coaxially with the rubbing rotatable member 391 and which is rotated integrally with the rubbing rotatable member 391, and the drive transmission member (first idler roller) 342 which transmits the driving force received from the drive input member 376 toward the driving member 344. And, in the present Embodiment, the drive transmission member 342 is rotatably provided about the rotational axis (second rotational axis) C2 of the second supporting member 372, the drive input member 376 is engaged with the drive transmission member 342 in the state in which the fixing rotatable member 330 is supported by the first supporting member 363, and the separating/contacting mechanism 396 rotates the second supporting member 372 so as to move the rubbing rotatable member 391 to the first position and the second position in the state of being drive-connected to the driving member 344 from the drive input member 376 via the drive transmission member 342.

In the present Embodiment, the first supporting member 363 includes the rotatable shaft 375, the second supporting member 372 is rotatably attached to the rotatable shaft 375, and the drive transmission member 342 is rotatably attached to the rotatable shaft 375. In addition, in the present Embodiment, the drive transmission member (first idler roller) 342 is a first drive transmission member, and the fixing device 30 includes a second drive transmission member (the second idler roller) 343 which is supported by the second supporting member 371 so as to be rotated by being engaged with the first drive transmission member 342 and the driving member 344, and transmits the driving force received from the first drive transmission member 342 to the driving member 344. In addition, in the present Embodiment, the rubbing rotatable member 391 is rotated with the peripheral speed difference to the fixing rotatable member 330. In addition, in the present Embodiment, the rubbing rotatable member 391 includes the abrasive grain 391c contactable with the fixing rotatable member 330. In addition, in the present Embodiment, the fixing device 30 includes the cleaning member (cleaning roller) 392 which is supported by the second supporting member 372 and cleans the rubbing rotatable member 391 by being in contact with the rubbing rotatable member 391, and the second supporting member 372 moves the rubbing rotatable member 391 and the cleaning member 392 by being rotated in the state in which the cleaning member 392 is in contact with the rubbing rotatable member 391. In addition, in the present Embodiment, the fixing rotatable member (the pressing roller) 330 is a first fixing rotatable member, the fixing device 30 includes a second fixing rotatable member (the fixing belt) 310 which forms the fixing nip portion N with the first fixing rotatable member 330, the separating/contacting mechanism (pressing refreshing roller separating/contacting mechanism) 396 is a first separating/contacting mechanism, the first supporting member 363 is capable of moving so as to move the first fixing rotatable member 330 between a third position (the contact position) where the first fixing rotatable member 330 is in contact with the second fixing rotatable member 310 and a fourth position (the separated position) where the first fixing rotatable member 330 is separated from the second fixing rotatable member 310, and the fixing device 30 includes a second separating/contacting mechanism (the pressing roller separating/contacting mechanism) 385 which moves the first supporting member 363. In the present Embodiment, the first separating/contacting mechanism 396 is capable of rotating the second supporting member 372 so as to move the rubbing rotatable member 391 between the first position and the second position in the state in which the first fixing rotatable member 330 is in the fourth position. In addition, in the present Embodiment, the first separating/contacting mechanism 396 is capable of rotating the second supporting member 372 so as to move the rubbing rotatable member 391 between the first position and the second position in the state in which the first fixing rotatable member 330 is in the third position. In addition, in the present Embodiment, the second fixing rotatable member 310 is the heating rotatable member which heats the recording material P, and the first fixing rotatable member 330 is the pressing rotatable member which is in press contact with the heating rotatable member. In addition, the image forming apparatus 1 in the present Embodiment includes the image forming portion 100 which forms the toner image on the recording material P, and the fixing device 30 in the present Embodiment which fixes the toner image formed by the image forming portion 100 onto the recording material P.

As described above, in the present Embodiment, to the rotatable shaft 375 provided to the pressing upper arm 363, the refreshing arm 372 is rotatably attached, and the first idler gear 342 is rotatably attached. And, in the state of being drive-connected from the drive input gear 376, which is provided on (coaxially with) the shaft of the pressing roller 330, to the refreshing gear 344, the separating/contacting operation of the pressing roller 330 with respect to the fixing belt 310 and the separating/contacting operation of the refreshing roller 391 with respect to the pressing roller 330 are performed. With such a configuration, even in the case in which the pressing roller 330 is thermally expanded, it becomes possible, without experiencing tooth skipping of the gears, to perform the drive connection from the drive input gear 376 to the refreshing gear 344, and perform the refreshing mode.

In this manner, according to the present Embodiment, even in the case in which the pressing roller 330 is thermally expanded, the distances between axes of the drive connecting portions are not changed, so that it becomes possible to suppress occurrence of abnormal noise and rotational failure of the gears due to the tooth skipping of the gears. Incidentally, according to the present Embodiment, the distances between axes of the drive connection portions are guaranteed, so that an effect that it becomes possible to suppress the rotational failure, the abnormal noise, breakage of the gears, etc. to occur due to insufficient backlash also can be obtained. Therefore, according to the present Embodiment, in the configuration in which the surface of the fixing rotatable member is rubbed by the rubbing rotatable member, regardless of the heat storage state, etc. of the fixing rotatable member, it becomes possible to appropriately transmit the driving force to the rubbing rotatable member.

### Embodiment 2

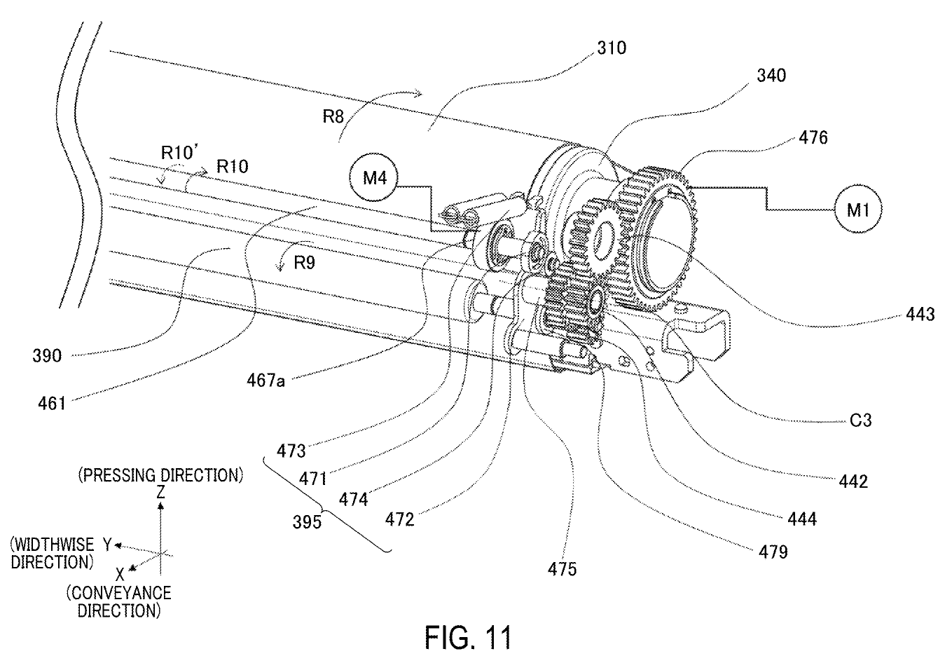

An Embodiment 2 will be described using FIGS. 11, 12 and 13. In the Embodiment 2, a case in which refreshing is performed to the fixing belt 310 will be described.

First, a configuration of a belt refreshing roller separating/contacting mechanism 395 in the present Embodiment will be described.

The belt refreshing roller separating/contacting mechanism 395 is configured to include a belt refreshing cam shaft 461, a belt refreshing cam 471, a belt refreshing arm 472, a belt refreshing spring 473, and a belt refreshing cam follower 474. The belt refreshing cams 471 are fixed to both end portions in a rotational axis direction of the belt refreshing cam shaft 461, respectively.

The belt refreshing arm 472 is supported rotatably (swingably) about a third rotational axis C3, which is approximately parallel to the rotational axis of the heating roller 340. Of the belt refreshing spring 473, which is constituted by a tension coil spring and is an urging member as an urging means, one end portion is engaged with the belt refreshing arm 472, and the other end portion is engaged with a frame (not shown). To the respective belt refreshing arms 472, belt refreshing supporting portions 479 for rotatably supporting the belt refreshing roller 390 are provided, respectively. The belt refreshing cam follower 474 is constituted by a roller, and is rotatably supported by the belt refreshing arm 472.

In addition, to one end portion of the belt refreshing cam shaft 461, which is an end portion on the front side in the present Embodiment, a belt refreshing cam driving gear 467a is provided. The belt refreshing cam shaft 461 is connected, via a gear train (not shown) which is configured to include the cam driving gear 467a, to a belt refreshing pressing driving motor M4 as a separating/contacting mechanism driving portion (driving source). The belt refreshing pressing driving motor M4 rotationally drives the belt refreshing cam shaft 461, and operates the belt refreshing roller separating/contacting mechanism 395.

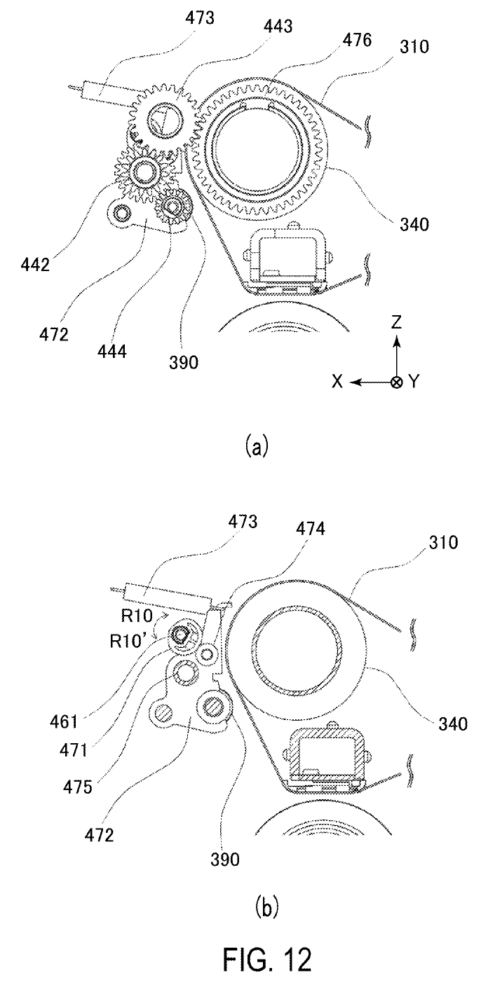

As shown in FIG. 12, when the belt refreshing cam shaft 461 is rotated in a forward rotational direction (direction of an arrow R10 in part (b) of FIG. 12), and the belt refreshing cam 471 pushes up the belt refreshing arm 472 in a direction in which the belt refreshing roller 390 is separated from the fixing belt 310 via the belt refreshing cam follower 474, the belt refreshing arm 472 is rotated against an elastic force of the belt refreshing spring 473. As a result, the belt refreshing roller 390 supported by the refreshing arm 472 is moved in a direction separated from the fixing belt 310.

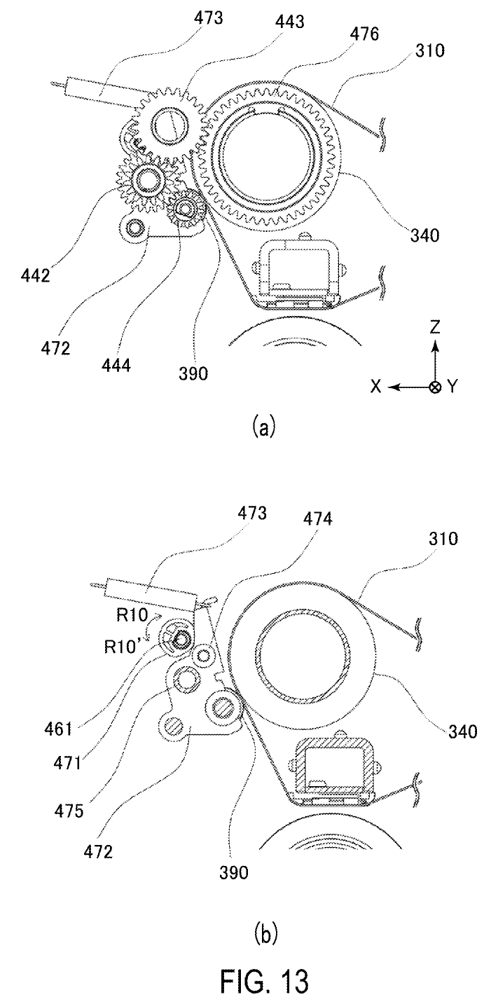

Conversely, as shown in FIG. 13, when the cam shaft 461 is rotated in a reverse rotational direction (direction of an arrow R10' in part (b) of FIG. 13), by the belt refreshing spring 473, the belt refreshing roller 390 supported by the belt refreshing arm 472 is pressed in a direction coming into contact with the fixing belt 310.

In addition, to a rotatable shaft 475, which is provided to the belt refreshing arm 472, on one end portion side in a rotational axis direction of the fixing belt 310, which is the front side in the present Embodiment, a first belt idler gear (drive receiving gear) 442 as a drive transmission member is rotatably attached. More specifically, the first belt idler gear 442 is rotatably attached, by the rotatable shaft 475 being passed through a rotation hole (not shown) provided to the first belt idler gear 442, to the rotatable shaft 475. To this rotatable shaft 475, as described above, the belt refreshing arm 472 is also rotatably attached. The first belt idler gear 442 is meshed with a belt refreshing gear (driving gear) 444 as a driving member, which is provided to an end portion on the front side of the belt refreshing roller 390, which is supported by the belt refreshing arm 472. In addition, to a frame (not shown), a second belt idler gear 443 is rotatably provided so as to be meshed with the first belt idler gear 442.

On the other hand, to the one end portion in the rotational axis direction of the heating roller 340, which is the end portion on the front side in the present Embodiment, a heating roller gear 476 as a drive input member is provided. In addition, as a result, from the heating roller gear 476, via the second belt idler gear 443 and the first idler gear 442, to the belt refreshing gear 444, all gears are drive-connected, and it becomes possible for the rotation of the heating roller 340 to be transmitted to the belt refreshing roller 390. When the heating roller 340 is rotated, the refreshing roller 390 is also rotated, and when the rotation of the heating roller 340 is stopped, the rotation of the refreshing roller 390 is also stopped.

In addition, the heating roller gear 476 is connected to the fixing driving motor M1 via a gear train (not shown). In addition, the heating roller 340 is rotationally driven by a driving force transmitted from the fixing driving motor M1. In the refreshing mode, the fixing driving motor M1 is driven at the predetermined speed (refreshing speed). As a result, the heating roller 340 is rotated in a direction of an arrow R8 in FIG. 11 at a peripheral speed of 200 mm/s, and the belt refreshing roller 390 is rotated in a direction of an arrow R9 in FIG. 11 at a peripheral speed of 350 mm/s. So as the belt refreshing roller 390 to be rotated under the condition in this manner, gear ratios among the heating roller gear 476, the first belt idler gear 442, the second belt idler gear 443, and the belt refreshing gear 444 are set.

As described above, in the present Embodiment, to the rotatable shaft C3 provided to the belt refreshing arm 472, the first belt idler gear 442 is rotatably attached. In addition, in the state of being drive-connected from the heating roller gear 476 provided on (coaxially with) the shaft of the heating roller 340 to the belt refreshing gear 444, the separating/contacting operation of the belt refreshing roller 390 to the fixing belt 310 is performed. With such a configuration, even in a case in which the temperature of the heating roller 340 rises and the heating roller 340 is thermally expanded, it becomes possible, without experiencing tooth skipping of the gears, to perform the drive connection from the heating roller gear 476 to the belt refreshing gear 444, and perform the refreshing mode.

### Embodiment 3

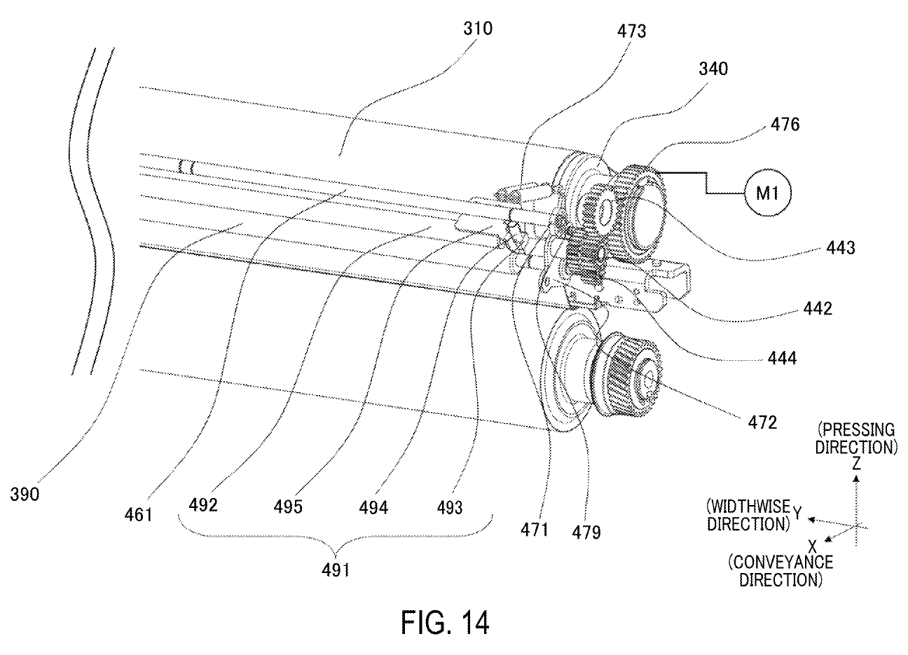

An Embodiment 3 will be described using FIGS. 14, 15, 16, and 17. In the Embodiment 3, a cleaning mechanism, which can suppress wearing of the abrasive grain on the surface of the belt refreshing roller 390 even in a configuration in which the belt refreshing roller 390 is always rotated even in a state of being separated from the fixing belt 310 as in the Embodiment 2, will be described.

First, a problem of the cleaning mechanism, which arises in a case in which the belt refreshing roller separating/contacting mechanism 395 as described in the Embodiment 2 is used, will be described. In the Embodiment 2, by all gears being drive-connected from the heating roller gear 476, via the second belt idler gear 443 and the first idler gear 442, to the belt refreshing gear 444, the rotation of the heating roller 340 is always transmitted to the belt refreshing roller 390 regardless of the contact/separated positions of the belt refreshing roller 390. As a result, even in the case in which the temperature of the heating roller 340 rises and the heating roller 340 is thermally expanded, it becomes possible, without experiencing the tooth skipping of the gears, to perform the drive connection from the heating roller gear 476 to the belt refreshing gear 444, and perform the belt refreshing mode. However, as a result, a cleaning roller 492, which is rotated driven by the rotation of the belt refreshing roller 390, always continues to rub the belt refreshing roller 390 even while the belt refreshing mode is not executed, and the abrasive grain on the surface of the belt refreshing roller 390 is excessively consumed.

A cleaning mechanism 491 for the belt refreshing roller 390 in the present Embodiment, which solves the problem described above, will be described using FIG. 14. The cleaning mechanism 491 urges, during execution of the belt refreshing mode, in other words, in the state in which the belt refreshing roller 390 is at the position contacting the fixing belt 310, the cleaning roller 492 to the belt refreshing roller 390 at a desired urging force, and makes it possible for the cleaning roller 492 to clean the surface of the belt refreshing roller 390. In addition, the cleaning mechanism 491 makes it possible that, during non-execution of the belt refreshing mode, in other words, in the state in which the belt refreshing roller 390 is at the position separated from the fixing belt 310, the urging force applied to the cleaning roller 492 toward the belt refreshing roller 390 becomes smaller than the urging force during execution of the belt refreshing mode. The cleaning mechanism 491 is constituted by the cleaning roller 492 as a cleaning member, a bearing 493, a cleaning roller urging spring 494, and a bearing supporting member 495. The cleaning roller 492 is supported by a frame (not shown) via the bearing 493 and the bearing supporting member 495. The cleaning roller 492 is urged so as to be in sliding contact with the surface of the belt refreshing roller 390 by the cleaning roller urging spring 494, and is rotated driven by the rotation of the belt refreshing roller 390. A position of the cleaning roller 492 is changed so as to follow the separating/contacting operation of the belt refreshing roller 390. The cleaning roller urging spring 494 is a compression spring, of which one end portion is engaged with the bearing 493, and the other end portion is engaged with the frame (not shown). The bearing supporting member 495 supports the bearing 493 so as to guide the bearing 493 in an urging direction of the cleaning roller urging spring 494. The cleaning roller 492 removes, by causing a brush provided on a surface thereof to rub against the surface of the belt refreshing roller 390, a minute amount of the toner and paper dust accumulated between the abrasive grains on the surface of the belt refreshing roller 390, and dust of the tube which forms and is abrased from the surface layer of the fixing belt 310. As a result, it is prevented that a surface state of the belt refreshing roller 390 is deteriorated, and an effect of maintaining the surface roughness of the surface layer of the fixing belt 310 at a constant state comes not to be exhibited. However, in the configuration in which the belt refreshing roller 390 is always rotated even while the belt refreshing mode is not executed, the brush on the surface of the cleaning roller 492 always continues to rub the abrasive grains on the surface of the belt refreshing roller 390, which causes a decrease in a lifetime of the belt refreshing roller 390.

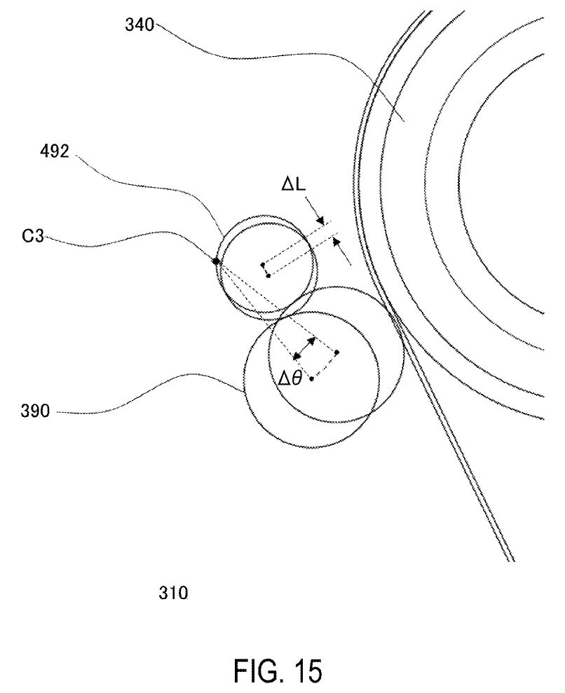

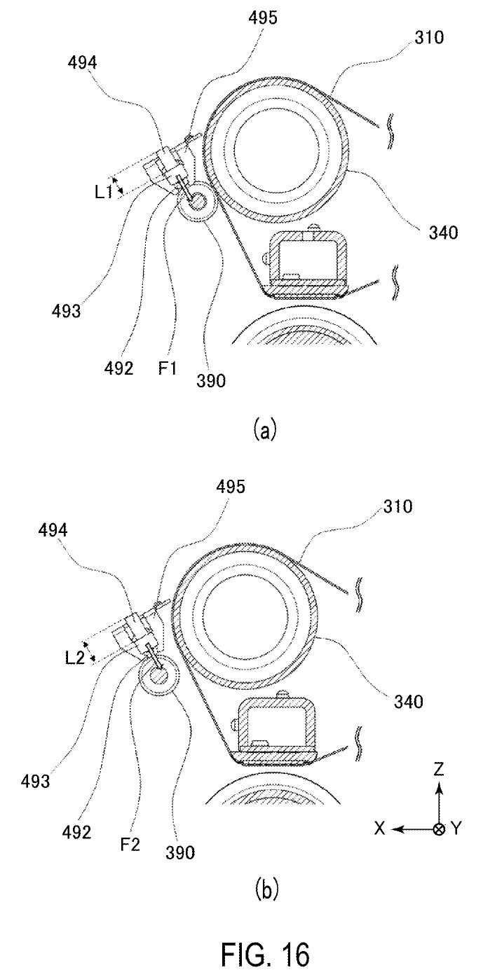

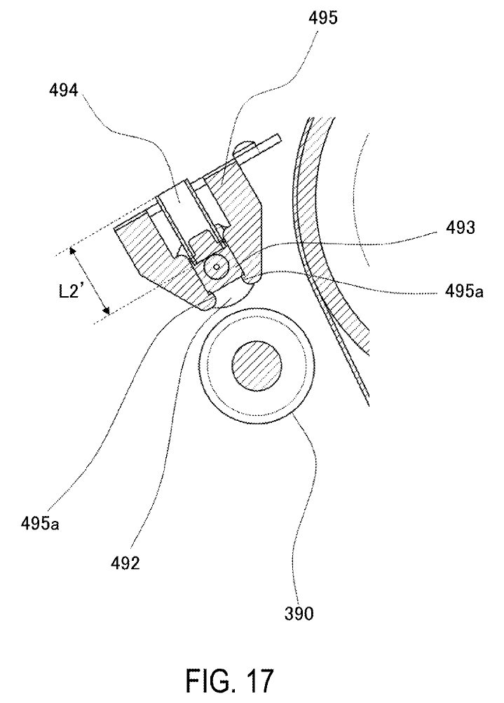

Next, an operation of the cleaning roller 492, which follows the separating/contacting operation of the belt refreshing roller 390, and a change in contact pressure will be described using FIGS. 15, 16, and 17. FIG. 15 illustrates a state in which the position of the cleaning roller 492 is changed following the separating/contacting operation of the belt refreshing roller 390. As to the belt refreshing roller 390, the position thereof is changed by Δθ about the rotatable shaft C3 of the belt refreshing arm 472 due to the separating/contacting operations. As to the cleaning roller 492, the position thereof is changed by ΔL (ΔL = L2 - L1) so as to follow the change in the position of the belt refreshing roller 390. Part (a) of FIG. 16 illustrates a state in which the belt refreshing roller 390 is at the contact position contacting the fixing belt 310, and part (b) of FIG. 16 illustrates a state in which the belt refreshing roller 390 is at the separated position separated from the fixing belt 310. Along with the operation in which the belt refreshing roller 390 is moved from the contact position to the separated position, the position of the cleaning roller 492 is changed, and the cleaning roller urging spring 494 is extended from a length L1 to a length L2 (L1 < L2). As a result, the urging force, at which the cleaning roller urging spring 494 urges the cleaning roller 492 to the belt refreshing roller 390, is changed from an urging force F1 at the contact position to an urging force F2 at the separated position (F1 > F2). In the present Embodiment, the urging force F1 at the contact position is set to approximately 3 N in order to obtain a desired cleaning capability. On the other hand, at the separated position, in order to suppress that the abrasive grains on the surface of the belt refreshing roller 390 are excessively consumed by the rubbing of the cleaning roller 492, it is preferable that the urging force F2 at the separated position be smaller than 3 N, and is set to be 2.4 N in the present Embodiment. As for the urging force F2 at the separated position, by adopting a configuration as shown in FIG. 17, for example, it may be set so that F2 becomes 0 N. FIG. 17 shows a configuration example, which is set so that the cleaning roller 492 is completely separated from the belt refreshing roller 390 at the separated position and F2 becomes 0 N. In this configuration example, at a position where the cleaning roller urging spring 494 becomes a certain length L2' (L1 < L2' < L2) while being extended from the length L1 at the contact position to the length L2 at the separated position, the bearing 493 abuts against a stopping portion 495a, which is provided at a leading end of the bearing supporting member 495, so that a changing range of the cleaning roller 492 is limited. By this, it becomes possible to completely separate the cleaning roller 492 from the belt refreshing roller 390 at the separated position, and set so as F2 to be 0 N.

As described above, in the present Embodiment, the cleaning mechanism 491 is configured so that the urging force F2 of the cleaning roller when the belt refreshing roller 390 is at the separated position becomes smaller than the urging force F1 when the belt refreshing roller 390 is at the contact position. By adopting such a configuration for the cleaning of the belt refreshing roller, even in the configuration in which the belt refreshing gear 444 is drive-connected to the heating roller gear 476 and the belt refreshing roller 390 is also always rotated when the heating roller 340 is rotated, it becomes possible to suppress the wearing of the abrasive grains on the surface of the belt refreshing roller 390.

### Other Embodiments

As described above, the present invention has been described according to the specific Embodiments, however, the present invention is not limited to the Embodiments described above.

In the Embodiments described above, examples in which the present invention is applied to the drive connecting portion between the pressing rotatable member, which is the fixing rotatable member, and the rubbing rotatable member, which rubs the pressing rotatable member, has been described, however, the present invention may be applied to a drive connecting portion between a heating rotatable member, which is a fixing rotatable member, and a rubbing rotatable member, which rubs the heating rotatable member. The heating rotatable member may be, for example, a member which has a roller shape and is provided with a heat source in an inside (a hollow portion) thereof, etc.

In addition, the present invention may also be applied to drive transmission to a rubbing rotatable member, which rubs a fixing rotatable member (pressing rotatable member, heating rotatable member) constituted by an endless belt. In this case, the present invention may be applied to a drive connecting portion between a stretching roller, which stretches the fixing rotatable member, and the rubbing rotatable member. The rubbing rotatable member is disposed, for example, so as to rub a surface of the belt at a portion which is wound around this stretching roller. This stretching roller may be, in a case in which the belt is a pressing rotatable member, for example, a roller functioning as a pressing roller which forms the fixing nip portion, etc. In addition, this stretching roller may be, in a case in which the belt is a heating rotatable member, for example, a roller functioning as a heating roller which heats the belt, etc. As for further description regarding such a configuration, the description for the Embodiments described above is incorporated by reading that the rubbed surface is the surface of the belt instead of the surface of the pressing roller, and the roller which is drive-connected to the rubbing rotatable member is the stretching roller instead of the pressing roller.

In addition, in the Embodiments described above, the case in which the refreshing mode is automatically executed at a predetermined timing by the control portion has been described as an example, however, the present invention is not limited thereto. For example, it may be configured that, in a case in which a user is bothered by a streak on an image, etc., the refreshing mode can be arbitrarily executed by inputting an instruction from the operating portion 4 to the control portion 5.

In addition, in the Embodiments described above, the pressing roller separating/contacting mechanism is a mechanism which causes the pressing roller to be in contact with and separated from the fixing belt by being rotated, however, for example, the pressing roller separating/contacting mechanism may be a mechanism which cause the pressing roller to be in contact with and separated from the fixing belt by being linearly reciprocated. In addition, the present invention may also be applied to a configuration, which does not include a mechanism which moves a rotatable member (a pressing rotatable member, a heating rotatable member, or a stretching roller for a belt as a fixing rotatable member), which is drive-connected to a rubbing rotatable member, so as to be in contact with and separated from a contacted member directly or across the belt. In this case, a mechanism which moves the contacted member so as to be in contact with and separated from the rotatable member directly or across the belt may be provided.

In addition, in the Embodiments described above, the shaft portion is provided to the pressing upper arm so as the refreshing arm and the first idler gear to be rotated about the common rotational axis, however, the present invention is not limited thereto. For example, a shaft member which is passed through holes provided in the pressing upper arm and the first idler gear, may be separately provided, or a shaft portion, which is provided to the first idler gear, may be passed through holes provided in the pressing upper arm and the refreshing arm.

In addition, in the Embodiments described above, the image forming apparatus is a color image forming apparatus, however, the present invention may also be applied to, for example, a monochrome image forming apparatus for a single color of black.

According to the present invention, in the configuration in which the surface of the fixing rotatable member is rubbed by the rubbing rotatable member, it becomes possible, regardless of the heat storage state of the fixing rotatable member, etc., to appropriately transmit the driving force to the rubbing rotatable member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2025-082981 filed on May 17, 2025, and 2026-072857 filed on Apr. 24, 2026, which are hereby incorporated by reference herein in their entirety.

What is claimed is:

1. A fixing device for heating a toner image on a recording material nipped and conveyed in a fixing nip portion, and for fixing the toner image onto the recording material, the fixing device comprising:
a fixing rotatable member configured to form the fixing nip portion;
a first supporting member configured to support the fixing rotatable member;
a rubbing rotatable member configured to rub a surface of the fixing rotatable member;
a second supporting member configured to support the rubbing rotatable member, the second supporting member being rotatable relative to the first supporting member so as to move the rubbing rotatable member between a first position where the rubbing rotatable member is in contact with the fixing rotatable member and a second position where the rubbing rotatable member is separated from the fixing rotatable member;
a separating/contacting mechanism configured to rotate the second supporting member;
a drive input member provided coaxially with the fixing rotatable member and configured to be rotated integrally with the fixing rotatable member;
a driving member provided coaxially with the rubbing rotatable member and configured to be rotated integrally with the rubbing rotatable member; and
a drive transmission member configured to transmit a driving force received from the drive input member toward the driving member,
wherein the drive transmission member is rotatably provided about a rotational axis of the second supporting member,
wherein the drive input member is engaged with the drive transmission member in a state in which the fixing rotatable member is supported by the first supporting member, and
wherein the separating/contacting mechanism rotates the second supporting member so as to move the rubbing rotatable member to the first position and the second position in a state of being drive-connected to the driving member from the drive input member via the drive transmission member.

2. The fixing device according to claim 1, wherein the first supporting member includes a rotatable shaft, the second supporting member is rotatably attached to the rotatable shaft, and the drive transmission member is rotatably attached to the rotatable shaft.

3. The fixing device according to claim 1, wherein the drive transmission member is a first drive transmission member, and
the fixing device includes a second drive transmission member supported by the second supporting member so as to be rotated by being engaged with the first drive transmission member and the driving member, and configured to transmit the driving force received from the first drive transmission member toward the driving member.

4. The fixing device according to claim 1, wherein the rubbing rotatable member is rotated with a peripheral speed difference to the fixing rotatable member.

5. The fixing device according to claim 1, wherein the rubbing rotatable member includes an abrasive grain contactable with the fixing rotatable member.

6. The fixing device according to claim 1, further comprising a cleaning member supported by the second supporting member and configured to clean the rubbing rotatable member be in contact with the rubbing rotatable member,
wherein the second supporting member moves the rubbing rotatable member and the cleaning member by being rotated in a state in which the cleaning member is in contact with the rubbing rotatable member.

7. The fixing device according to claim 1, wherein the fixing rotatable member is a first fixing rotatable member, and
the fixing device includes a second fixing rotatable member configured to form the fixing nip portion with the first fixing rotatable member, and
wherein the separating/contacting mechanism is a first separating/contacting mechanism, and
wherein the first supporting member is capable of moving so as to move the first fixing rotatable member between a third position where the first fixing rotatable member is in contact with the second fixing rotatable member and a fourth position where the first fixing rotatable member is separated from the second fixing rotatable member, and
the fixing device includes a second separating/contacting mechanism configured to move the first supporting member.

8. The fixing device according to claim 7, wherein the first separating/contacting mechanism is capable of rotating the second supporting member so as to move the rubbing rotatable member between the first position and the second position in a state in which the first fixing rotatable member is in the fourth position.

9. The fixing device according to claim 7, wherein the first separating/contacting mechanism is capable of rotating the second supporting member so as to move the rubbing rotatable member between the first position and the second position in a state in which the first fixing rotatable member is in the third position.

10. The fixing device according to claim 7, wherein the second fixing rotatable member is a heating rotatable member configured to heat the recording material, and the first fixing rotatable member is a pressing rotatable member configured to be in press contact with the heating rotatable member.

11. A fixing device for heating a toner image on a recording material nipped and conveyed in a fixing nip portion, and for fixing the toner image onto the recording material, the fixing device comprising:
an endless belt configured to form the fixing nip portion;
a roller configured to stretch the belt;
a first supporting member configured to support the roller;
a rubbing rotatable member configured to rub a surface of the belt;
a second supporting member configured to support the rubbing rotatable member, the second supporting member being rotatable relative to the first supporting member so as to move the rubbing rotatable member between a first position where the rubbing rotatable member is in contact with the belt and a second position where the rubbing rotatable member is separated from the belt;
a separating/contacting mechanism configured to rotate the second supporting member;
a drive input member provided coaxially with the rubbing rotatable member and configured to be rotated integrally with the rubbing rotatable member;
a driving member provided coaxially with the rubbing rotatable member and configured to be rotated integrally with the rubbing rotatable member; and
a drive transmission member configured to transmit a driving force received from the drive input member toward the driving member,
wherein the drive transmission member is rotatably provided about a rotational axis of the second supporting member,
wherein the drive input member is engaged with the drive transmission member in a state in which the roller is supported by the first supporting member, and
wherein the separating/contacting mechanism rotates the second supporting member so as to move the rubbing rotatable member to the first position and the second position in a state of being drive-connected to the driving member from the drive input member via the drive transmission member.

12. A fixing device for heating a toner image on a recording material nipped and conveyed in a fixing nip portion, and for fixing the toner image onto the recording material, the fixing device comprising:
an endless belt configured to form the fixing nip portion;
a roller configured to stretch the belt;
a first supporting member configured to support the roller;
a rubbing rotatable member configured to rub a surface of the belt;
a second supporting member configured to support the rubbing rotatable member, the second supporting member being rotatable relative to the first supporting member so as to move the rubbing rotatable member between a first position where the rubbing rotatable member is in contact with the belt and a second position where the rubbing rotatable member is separated from the belt;
a cleaning roller configured to perform cleaning by being in contact with the rubbing rotatable member; and
a cleaning roller urging means configured to change a contact pressure between the rubbing rotatable member and the cleaning roller with movement of the rubbing rotatable member between the first position and the second position by the second supporting member,
wherein the contact pressure by the cleaning roller urging means when the rubbing rotatable member is in the second position is smaller than the contact pressure by the cleaning roller urging means when the rubbing rotatable member is in the first position.

13. The fixing device according to claim 12, further comprising:
a separating/contacting mechanism configured to rotate the second supporting member;
a drive input member provided coaxially with the rubbing rotatable member and configured to be rotated integrally with the rubbing rotatable member;
a driving member provided coaxially with the rubbing rotatable member and configured to be rotated integrally with the rubbing rotatable member; and
a drive transmission member configured to transmit a driving force received from the drive input member toward the driving member,
wherein the drive transmission member is rotatably provided about a rotational axis of the second supporting member,
wherein the drive input member is engaged with the drive transmission member in a state in which the roller is supported by the first supporting member, and
wherein the separating/contacting mechanism rotates the second supporting member so as to move the rubbing rotatable member to the first position and the second position in a state of being drive-connected to the driving member from the drive input member via the drive transmission member.
